(19) United States
(12) Patent Application Publication
(10) Pub. No.: US 2025/0101184 A1
(43) Pub. Date: Mar. 27, 2025

(54) Phosphorylation of Lignin with Phytic Acid Improves Thermal Stability and Flame Retardancy Performance

(71) Applicant: Lakehead University, Thunder Bay (CA)

(72) Inventors: Pedram Fatehi, Thunder Bay (CA); Saba Khodavandegar, Thunder Bay (CA)

(21) Appl. No.: 18/887,630

(22) Filed: Sep. 17, 2024

Related U.S. Application Data
(60) Provisional application No. 63/584,650, filed on Sep. 22, 2023.

(51) Int. Cl. C08H 7/00; C08K 5/521; C09D 5/00; C09D 7/63; C09D 197/00

(52) U.S. Cl. CPC C08H 6/00; C08K 5/521; C09D 5/00; C09D 7/63; C09D 197/005

(57) ABSTRACT

Kraft lignin was modified with phytic acid (C₆H₁₈O₂₄P₆ PHA), a bio-based reagent with high amount of phosphorus, in a facile solvent-free reaction at low temperature, to produce a novel reactive bio-based flame retardant. The thermochemical properties of the fabricated lignin derivative were comprehensively analyzed by advanced tools, such as ¹H NMR, ³¹P NMR, HSQC-NMR, XPS, ICP-AES, TGA, and DSC. A smoke detector and limiting oxygen index investigated the flame retardancy behavior of modified lignin used for coating wood samples.

### PRIOR APPLICATION INFORMATION

The instant application claims the benefit of US Provisional Patent Application U.S. 63/584,650, filed Sep. 22, 2023, entitled “PHOSPHORYLATION OF LIGNIN WITH PHYTIC ACID IMPROVES THERMAL STABILITY AND FLAME RETARDANCY PERFORMANCE”, the entire contents of which are hereby incorporated herein by reference for all purposes.

### BACKGROUND OF THE INVENTION

Flame retardant materials are used in various applications, including clothes, furniture, building materials, and electronics, to delay or prevent the spread of fire [1,2]. They are necessary for sectors where the fire risk is high, and safety is paramount. Minerals, such as halogenated, phosphorus-containing, nitrogen-containing, silicon-containing, and nano-metric compounds, are the major types of fire-retardant materials [3]. However, these flame retardants have been proven to have detrimental environmental and health effects, such as being persistent and bio accumulative, as well as potentially carcinogenic [4]. Earlier, halogen-based flame-retardant polychlorinated biphenyls (PCBs), and brominated flame retardants (BFRs), such as penta- and octa-bromodiphenyl ether and hexabro-mocyclododecane, were applied as a coating solution and in the rection medium, because of their efficiency in modifying fabrics and biopolymers. However, their use was restricted due to the generation of toxic gases during combustion, which is dangerous for humans, animals, and the environment [5,6]. Mineral flame retardants, such as aluminum trihydroxide, are particularly effective in reducing fire risk and are frequently utilized. Nevertheless, their low efficiency requires significant quantities to be used to attain the desired increased fire resistance characteristics [7]. There is a need to produce safer and more effective flame-retardant materials that fulfill environmental and health requirements. Considering environmental protection and human safety, halogenated flame retardants were replaced with biobased phosphorous materials. Specifically, generating phosphorous containing biomacromolecules is interesting as it can pave the way to generate sustainable flame retardants [8]. In this case, the phosphor containing flame retardant can function via promoting carbonization, dehydrogenation, and physical protective layer properties [4].

Lignin, among other biopolymers, has received attention due to its three-dimensional structure, vast availability [9], and biodegradability [10]. Lignin is an amorphous and complicated biopolymer made up of polyphenolic molecules as well as a reactive substance with many functional groups, including hydroxyl, phenoxyl, carbonyl, methoxy, and carboxyl [8]. In the past, lignin was modified to be used in applications such as drug delivery [11], antimicrobial [12], thermal insulation [13], flocculants and dispersant [14], and biosensors [15]. Lignin can be used as a flame retardant because of its active functional groups, aromatic ring, and ability to form char [16]. However, it cannot be used in pristine form as a flame retardant because of its low fire-resistant efficiency [17]. Alternatively, lignin can be modified to improve its flame retardancy and fire resistance. Generally, chemical reagents, like halogens, nitrogen, silane, and phosphor can be used to improve the flame retardancy of materials [18,19,20,21]. However, because phosphorous flame-retardant material has different oxidation states from 0 to +5 that can release fire in both gas and condensed phases, the variety of structures from organic to inorganic and different amounts of P content in phosphorous materials are a suitable alternative to other materials.

Phytic acid (PHA) is an eco-friendly organic acid and biocompatible material that widely exists in plants, leaves, and roots [22]. This biomass is considered an excellent flame retardant because of the six phosphorous molecules in its structure, which produces a char layer to protect and change the burning behavior of materials [23]. In the past, phytic acid was used with chitosan [24], silane sol [25], and collagen [26] to produce flame retardant materials. However, phytic acid is mostly used as an additive to these biomaterials and it tends to leach out from mixture which could affect the mechanical properties and processability of the flame retarding biopolymers. It was also used as a flame retardant for coating textile materials, but as it is soluble in water, the flame-retardant properties are reduced by washing the textile materials [27]. In this regard, it would be more effective if a flame retardant reagent covalently bonded to the material, as it can have a permanent flame retarding effect. Also, phosphor elements in a phytic acid structure are active that can covalently bond to the active functional groups and incorporated in the structure, resulting in excellent flame-retardant efficiency [28][29].

In previous studies, the modification of lignin was carried out mainly by different phosphorous reagents, for example, ammonium dihydrogen phosphate (NH₄H₂PO₄) [30], phosphorus pentoxide (P₂O₅) [31], phosphoric acid (H₃PO₄) [32,33,34], 9,10-dihydro-9-oxa-10-phosphaphenanthrene-10-oxide (DOPO) [35], O,O dialkylthiophosphoric acids [36], and sodium 3-chloro-2-hydroxypropyl phosphate [37]. However, phosphorous reagents, such as DOPO, need a high temperature to get activated for the reaction [38]. Generally, phosphorylation is conducted in the presence of urea and THF, which is essential for preventing the degradation of modified polymer structure, especially at high temperatures [39,40]. Interestingly, it was observed that the number of phosphorus molecules in a biomaterial is directly correlated to its flame retardancy [41]. Compared with the mentioned reagents, phytic acid (PHA) has six phosphorous elements on its backbone, and is eco-friendly that can be utilized in low temperature for the modification of lignin to achieve phosphorylated kraft lignin because of OH active sites on its structure [42].

### SUMMARY OF THE INVENTION

According to a first aspect of the invention, there is provided a method of preparing a flame modified lignin composition comprising:
mixing a quantity of lignin with phytic acid in water at a ratio of about 1 part lignin per about 0.2 to about 0.6 parts phytic acid (mol/mol) at a pH of about 9 to about 12 for at least about 20 minutes at a temperature of about 20-80° C.; and
recovering the modified lignin composition.

According to another aspect of the invention, there is provided a method of preparing a flame retardant composition comprising:
mixing a quantity of lignin with phytic acid in water at a ratio of 1 part lignin per 0.2 to 0.6 parts phytic acid (mol/mol) at a pH of 9 to 12 for at least 20 minutes at a temperature of 20-80° C.; and
recovering the modified lignin composition.

According to another aspect of the invention, there is provided use of the modified lignin composition in a flame retardant material.

According to another aspect of the invention, there is provided a method of increasing flame retardancy of a wood product comprising applying a coating comprising the modified lignin composition to a surface of the wood product.

### BRIEF DESCRIPTION OF THE DRAWINGS

FIG. 1. The chemosynthesis scheme of phosphorylation (a), scheme of all possibility of crosslinking (b).

FIG. 2. the effect of molar ratio (a), time (b), and temperature (c) on the reaction. The effect of molar ratio on molecular weight and phosphorous content (d).

FIG. 3. ¹H NMR spectra of KrL, and PK18. Shaded peaks are identified as described in the text.

FIG. 4. quantitative ³¹P NMR of KrL and PK18. Shaded peaks indicate the type of OH functional group.

FIG. 5. qualitative ³¹P NMR of KrL and PK18.

FIG. 6. HSQC NMR of KrL (a and d), PK18 in DMSO (b and e), aliphatic region of both KrL and PK18 in DMSO (c), PK18 in D₂O (f).

FIG. 7. FTIR spectra of KrL and PK18. Shaded peaks are identified as described in the text.

FIG. 8. XPS wide spectra (a), C 1s and O 1s of KrL (b and c), C 1s and O 1s, and P 2p of PK18 (d, e, and f).

FIG. 9. Thermal analysis of KrL, and PK18. TGA curves with an arrow indicating Tₘₐₓ (a). DSC curves showing the T_{g} and Cₚ (b).

FIG. 10. LOI value for uncoated wood (UW), KrL coated, and PK18 coated samples.

FIG. 11. Light absorption curves (a) and smoke density rating values (b) of the UW, KrL, and PC (PK18 coated) samples.

FIG. 12. SEM images of char residue after smoke detector analysis for UW (a-d), char residue after burning the UW (e), EDX of UW (f).

FIG. 13. SEM images of char residue after smoke detector analysis for PC3 (a-d), char residue after burning the PC3 (e), EDX of PC3 (f).

FIG. 14. Smoke density rating values (a) and light absorption curves (b) of the UW, KL, and PC (PK17 coated) samples.

FIG. 15. The SEM image (a and c), EDS elemental mapping, and EDX (b and d) of the surface of the PK17 before and after combustion.

### DESCRIPTION OF THE PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

In this work, kraft lignin was modified with C₆H₁₈O₂₄P₆ (PHA), a bio-based reagent with high amount of phosphorus, in a facile solvent-free reaction at low temperature, to produce a novel reactive bio-based flame retardant. The objective of this work was to optimize the reaction conditions to generate phosphorylated lignin with the maximum flame retardancy. Moreover, the thermochemical properties of the fabricated lignin derivative were comprehensively analyzed by advanced tools, such as ¹H NMR, ³¹P NMR, HSQC-NMR, XPS, ICP-AES, TGA, and DSC. A smoke detector and limiting oxygen index investigated the flame retardancy behavior of modified lignin used for coating wood samples.

As discussed herein, this is in contrast with melt blending methods, which require temperature around 160° C.

Specifically, as will be known by those of skill in the art, the phosphorylation reaction has previously been done at high temperatures in the presence of urea. The urea is added as a protection against decomposition at these high temperatures. As such, it was anticipated that it would not be possible to have high phosphorous content in a water-based reaction because temperatures could not exceed 80-90° C. However, as discussed herein, comparison of the method of the invention with methods using urea at high temperatures showed that, surprisingly, there was not much difference in charge density, solubility, and P content in comparison to water.

According to an aspect of the invention, there is provided a method of preparing a modified lignin composition comprising:
mixing a quantity of lignin with phytic acid in water at a ratio of about 1 part lignin per about 0.2 to about 0.6 parts phytic acid (mol/mol) at a pH of about 9 to about 12 for at least about 20 minutes at a temperature of about 20-80° C.; and recovering the modified lignin composition.

As used herein, “about” refers to the base value plus or minus 10%. As such, “about 10” means “9-11”.

According to another aspect of the invention, there is provided a method of preparing a modified lignin composition comprising:
mixing a quantity of lignin with phytic acid in water at a ratio of 1 part lignin per 0.2 to 0.6 parts phytic acid (mol/mol) at a pH of 9 to 12 for at least 20 minutes at a temperature of 20-80° C.; and
recovering the modified lignin composition.

The ratio may be about 1 part lignin per about 0.4 parts phytic acid (mol/mol).

The ratio may be 1 part lignin per 0.4 parts phytic acid (mol/mol).

The pH may be from about 9 to about 11.

The pH may be from 9 to 11.

The pH may be about 9.

The pH may be adjusted by addition of a base. The base may be NaOH.

As will be appreciated by one of skill in the art, increasing the amount of PHA will lead to an increase in crosslinking, which will reduce the solubility of the reaction product to an extent that pH adjustment cannot control it. Accordingly, in some embodiments wherein greater P content is desired, more phytic acid can be added, although the pH of the reaction would also have to be increased.

As discussed herein, the reaction is completed within about 20 minutes; increasing the time results in no significant change in charge density and solubility.

As will be known by those of skill in the art, carrying out the reaction at higher temperatures, for example, temperatures at more than 90-100° C., can result in the decomposition of KrL. Furthermore, at temperatures lower than room temperature, the mobility of molecules could decrease, which will result in a lower grafting ratio.

As will be apparent to those of skill in the art, PHA is acidic. By adding PHA to the reaction medium, the pH drops, which reduces the solubility of KrL. However, by adjusting the pH after adding the PHA, KrL active sites are deprotonated which allows for modification of the kraft lignin that results in more P content.

By this modification, the solubility of KrL increased from 30% to 98%, which makes it easy to solubilize in different solvents for coating applications. The easy way is dip coating; by immersing the wood in the solution, we can coat the wood. The coated wood can be used in different construction fields.

As will be appreciated, modifying kraft lignin with the phosphorous reagent to improve thermal stability and flame retardancy is essential for broadening its application into different fields. Bio-based flame retardants are one of the important replacements for halogen-based flame retardants because of their environmental benefits, renewability, and sustainability.

As discussed herein, a bio-based flame retardant was prepared by the solvent-free polycondensation reaction of kraft lignin (KrL) and bio-phosphorous regent phytic acid (PHA). The reaction conditions were optimized by considering the reaction's molar ratio, pH adjustment, solvent, temperature, and time, as discussed herein.

The optimized conditions for this reaction is the molar ratio of KrL:PHA (1: 0.4, mol:mol) in DI water as a solvent, 20 min, at 20° C. with pH adjustment to 11 after adding the reagent, followed by neutralization at the end of the reaction. As discussed herein, other suitable conditions will be apparent to those of skill in the art and are within the scope of the invention.

By this modification, the charge and solubility of KrL increased from −0.8 to −4 (mmol/g) and from 20% to 97%, respectively.

¹H NMR, ³¹P NMR, HSQC, XPS, ICP-AES, and FTIR were used to characterize the structure of this bio flame retardant, as discussed herein. The thermal properties of modified KrL were studied by TGA and DSC wherein the maximum decomposition temperature (Tₘₐₓ) increased from 545° C. to 650° C. while the glass transition temperature T_{g} increased from 180.80° C. to 215.22° C.

The flame retardancy performance of coated wood samples with phosphorylated kraft lignin (PK) were studied with limiting oxygen index and smoke detector analysis, which demonstrated that increasing the concentration of the solution increased the limiting oxygen index to 25% of oxygen concentration, and the smoke density rating decreased by 17.7%. As discussed below, this demonstrates that KrL was modified successfully with PHA.

Specifically, KrL was modified by C₆H₁₈O₂₄P₆ (PHA) in a solvent-free reaction to produce a novel reactive bio-based flame retardant. To optimize the reaction condition with the maximum P content, charge density, and solubility, a total of 23 experiments were run.

As discussed herein, the composition of the invention has improved char forming abilities. This is important because during combustion, triphenyl phosphate and triphenylphosphine oxide can break down into small radicals like HPO·, PO₂·, PO·, and P₂·. After ignition, these phosphorus radicals can work as a cleanser for H· and OH· radicals released in the gas phase during burning. Char will also form a condensed phase which will act as a protection layer that will not let heat and oxygen go to lower layers, thereby slowing the spread of the fire.

As discussed below, KrL was successfully modified with PHA to obtain a PK sample series with different phosphorous content with high thermal stability and flame retardancy properties.

Specifically, H NMR, FTIR, XPS, and ICP-AES analyses demonstrated the presence of phosphorous molecules and the new bond of C—O—P which confirms the polycondensation reaction of hydroxyl groups of KrL and PHA. Furthermore, P—O—P bonds show the crosslinking of P—OH after reaction which decreased the solubility by increasing the molar ratio. The ³¹P NMR results confirmed that the reaction occurred on aromatic, phenolic, and carboxylic hydroxyl groups. TGA and DSC analysis showed the thermal stability of modified KrL with PHA was significantly improved from 545° C. to 650° C. and char residue for the modified lignin at 800° C. 50%. LOI and smoke detector analysis showed that by increasing the concentration of the coating solution, the value of LOI increased by 26%, and the smoke release rate decreased by 17.7% due to the formation of more phosphorous crystals and char during burning, which was confirmed by SEM images. Specifically, SEM images gave positive evidence that phosphorous crystals can form a protection shield, penetrate the pores, and fill gaps and cracks during combustion.

As such, as discussed herein, a sustainable flame retardant was prepared in an aqueous medium, i.e., green solvent, from KL and PHA. In some embodiments, the reaction conditions that yielded the lignin derivative with the highest phosphorous element were KL: PHA of 1:0.4 mol/mol, reaction time, temperature, and pH of 20 min, 20° C., and 11, respectively. This optimized condition resulted in the PK17 with −4.2 mmol/g charge density, 9.7 g/L solubility in water, and MW of 4800 g/mol. The reaction under the optimized conditions decreased the aliphatic and phenolic hydroxyl groups of KL from 1.72 to 0.63 mmol/g and 3.33 to 0.71 mmol/g, respectively. ¹H, HSQC, and ³¹P NMR confirmed that the aliphatic and aromatic OH of KL participated in the reaction with PHA and generated a covalent bond of P—O—C. The qualitative ³¹P NMR confirmed three different crosslinking of phosphate groups based on reaction conditions, such as mono phosphate, phosphodiester, and orthophosphate. Also, FTIR, XPS, and ICP-AES analyses confirmed the presence of phosphorous elements and the new C—O—P bond between KL and PHA.

The TGA analysis confirmed that the phosphorylation of KL improved the thermal stability of lignin by improving its decomposition temperature from 545° C. to 650° C. char formation at 800° C., while KL did not produce any char at 625° C. The DSC results confirmed the increment in T_{g} from 180.8° C. to 215.2° C. after phosphorylation. The combustion completion was analyzed by SEM, EDX, and EDS for PK17, and the change in sample morphology from regular to irregular and increment in the intensity of phosphorus was confirmed after combustion. By increasing the concentration of PK17 solution from 1 wt. % to 3 wt. % in the wood coating process, the LOI of wood rose from 21.8% to 26.0%, and the smoke density rate decreased from 34.0% to 17.7% due to the formation of thermally stable char and release of non-flammable gases. The promising flame retarding performance of PK17 on wood and filer paper paves the way for the production pathway of PK17 as a simple and effective aqueous-based reaction to produce phosphorylated lignin.

The invention will now be further elucidated and/or explained by way of examples. However, the invention is not necessarily limited to or by the examples.

### Example 1: Solubility, Charge Density, and Molecular Weight Optimization

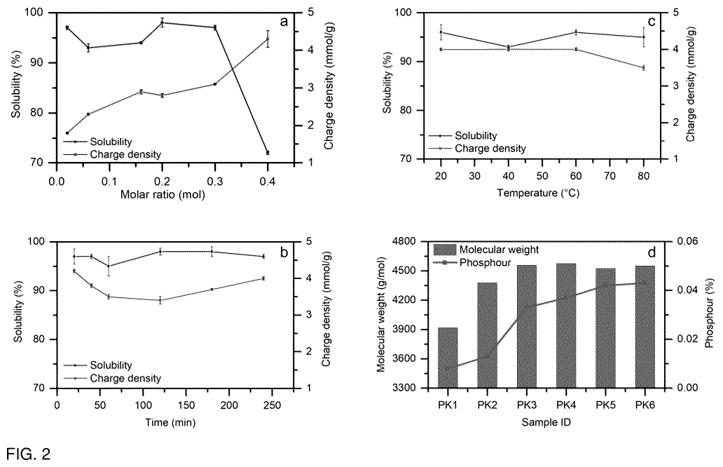

Solubility, charge density, and MW measurements were carried out to optimize the reaction conditions for obtaining the modified lignin with the highest phosphorylated group. The effect of different molar ratios of reagent is illustrated in FIGS. 2a to 2d. When the molar ratio increases from 0.02 to 0.4 mol, the phosphor (P) content, charge density, and molecular weight of phosphorylated lignin were increased from 0.8% to 4.4%, −1.8 mmol/g to −4.3 mmol/g, and 3920 g/mol to 4554 g/mol, respectively. However, because of the active sites of hydroxyl in both KrL and PHA, further increases in the amount of phytic acid causes crosslinking [43]. The result of this crosslinking is a decrease in solubility that occurs at a molar ratio of more than 0.4 mol. The result of CHNS analysis showed that by increasing the molar ratio of PHA/KrL, the C % and H % decreased from 62.7% (KrL) to 42.44% (PK6) and from 6.9% (KrL) to 5.37% (PK6), respectively. The sulfur content of the sample was less than 1.2%, which likely originated from kraft pulping and the acid treatment in the LignoBoost process [44].

The effect of pH of the reaction medium is illustrated in Table 1. Different pH adjustment scenarios were studied after the drop in solubility observed with the molar ratio (PK6) 1:0.4 (KrL:PHA, mol:mol). As discussed above, increasing the molar ratio causes the pH of the reaction medium to decrease, which causes the agglomeration and protonation of KrL. In strategy one, after adding reagent without any change in the pH, the reaction was exploited, and the samples were dialyzed (PK6 and PK11). In strategy two, the reaction was carried out without any pH adjustment, but the sample was neutralized before dialysis (PK8 and PK10). In strategy three, after adding the reagent, the pH of the reaction was adjusted to 11 and the reaction ran at pH 11. Afterward, the reaction medium was neutralized and dialyzed (PK7 and PK9). The hydroxyl and phosphate ions activity are pH dependent [45] and by increasing the molar ratio of reagent (PHA is acidic), the pH of the reaction medium was changed to a lower pH (acid) which affects the activity of both these groups [46]. At the lower pH (about 3 to 5) the phosphate groups are active and when the pH increases (about 9 to 11), both hydroxyl and phosphate groups are active which compete to interact with KrL and cause different crosslinking bonds like mono phosphate, phosphodiester, and orthophosphate [47]. When the pH of the reaction medium is acidic, because the particle flocculation is sensitive to pH, agglomeration increases [48]. Higher PHA concentrations suggest that the transformation from fractal-like to closed-packed aggregates is primarily attributed to the suppressed cross-linking process, as indicated by the decrease in solubility which was confirmed by H and P NMR [49]. By controlling the pH of the reaction with different strategies, this crosslinking can be controlled. Under the best strategy, which is the third one, the solubility increased from 72% to 97%, the P content increased from 0.041 g/g to 0.07 g/g, with a charge density of −4 mmol/g.

Also, the effect of urea (as a solvent) was studied at different temperatures, and the results are reported in Table 2. In earlier research, urea was utilized not only as a solvent but also as a degradation inhibitor at higher reaction temperatures (more than 90° C.), because most of the phosphorylation modification occurred between 90° C. to 120° C. [50]. However, surprisingly, both samples had the same phosphorus group, charge density, solubility, and other analysis results, as discussed herein.

The characteristics influencing the optimization of the phosphorylation of KrL were high charge density, solubility, and phosphorous content. These results were found under the optimized condition for (PK18) with the molar ratio of KrL:PHA (1: 0.4, mol:mol) in DI water, for 20 min, at 20° C. The pH strategy for this condition was pH adjustment after adding the reagent to 11, neutralization after the reaction and then purification. Based on these conditions, the obtained sample (PK18) had highest MW 4771, solubility 97%, and charge density −4.2 mmol/g and was chosen for further analysis.

### Example 2: NMR Characterization

### ¹H NMR

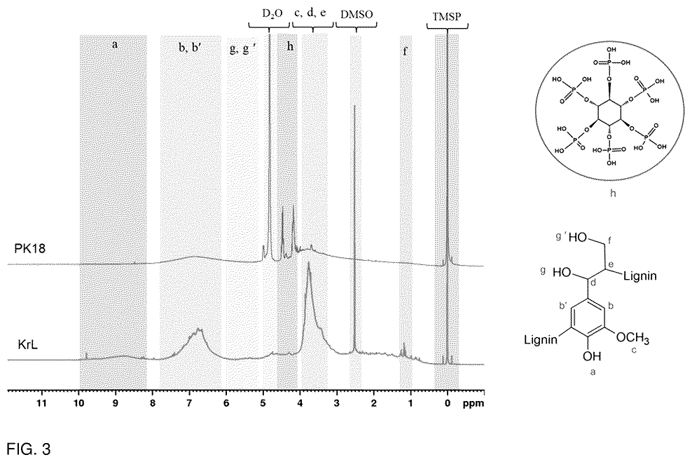

¹H NMR was used to characterize the chemical structure of PK18. The spectra in FIG. 3 confirm the changes in KrL structure after grafting PHA on the lignin structure. In the KrL spectrum, the protons of phenolic and aliphatic hydroxy groups are at chemical shifts around 8.7 (a) and 5.5 (g, g′) ppm, respectively. After the modification, both hydroxy groups participated in the reaction, and disappeared from the spectrum of PK18. The aromatic protons of the guaiacyl unit show a broad peak in the 7.5-6.1 ppm (b, b′). Intense peaks at 4.1-3.1 ppm are from the protons of methoxy groups on lignin structure (c, d, e). Three strong peaks at 4.70 ppm, 2.5, and 0 ppm belong to D₂O, DMSO, and TMSP that were used as solvents for sample preparation and internal standard, respectively. Also, two characteristic peaks in the PK18 graph at 4.5 and 4.2 ppm were ascribed to the PHA protons, showing phosphorylation successfully occurred [51].

By increasing the molar ratio of PHA/KrL, both aromatic and aliphatic hydrogens participated in the reaction. In addition, the intensity of the peaks in the range of 4-4.7 ppm, which shows the protons on phosphorous groups, was increased by increasing the molar ratio of PHA. The decrease in solubility by increasing the amount of reagent in PK6 is because of the crosslinking and interactions of the phosphorus groups that screen the structure of lignin and two peaks in the region 1-4 ppm that are assigned to protons of KrL, which were not involved in the reaction.

### ³¹P NMR Quantitative

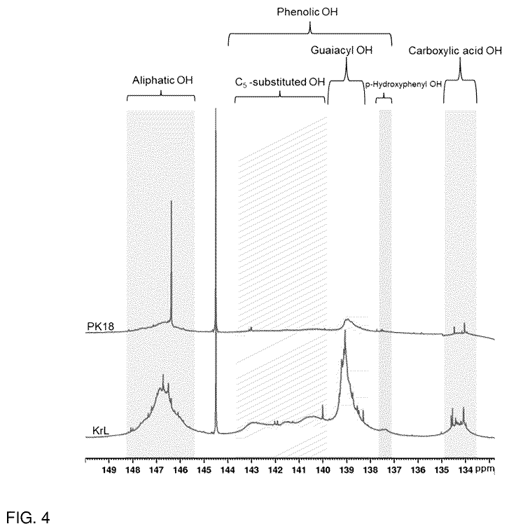

³¹P NMR spectroscopy was carried out to confirm the chemical structure of the KrL and PK18 samples. This analysis provided quantitative information on the concentration of each hydroxyl group of lignin participating in the reaction. The cyclohexanol peak (internal standard) is identified at 144.8 ppm. The results of this experiment are provided in FIG. 4 and Table 7. As can be seen, the decrease in the aliphatic, phenolic, and carboxylic hydroxy groups proves that these groups participated in the modification reaction. A significant drop in the amount of phenolic hydroxy group from 3.33 mmol/g to 0.63 mmol/g confirmed the high activity of phenolic hydroxyl groups in KrL and phosphorylation on this site by polycondensation [52]. After the phosphorylation of KrL, the aliphatic hydroxyl group decreased from 1.72 mmol/g to 0.63 mmol/g. In addition, there is a significant drop from 0.41 mmol/g to 0.06 mmol/g for carboxylic hydroxy content inferring that the reaction happened on the aliphatic, aromatic and carboxyl hydroxyl groups. The sharp peak in the phenolic hydroxyl region is for PHA's hydroxyl groups that confirms a successful phosphorylation reaction.

### ³¹P NMR Qualitative

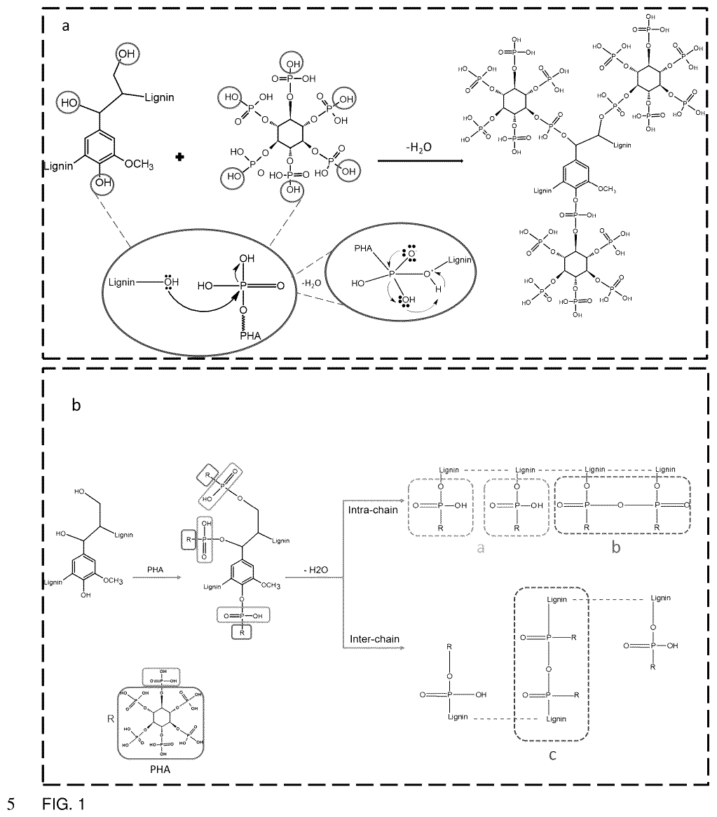

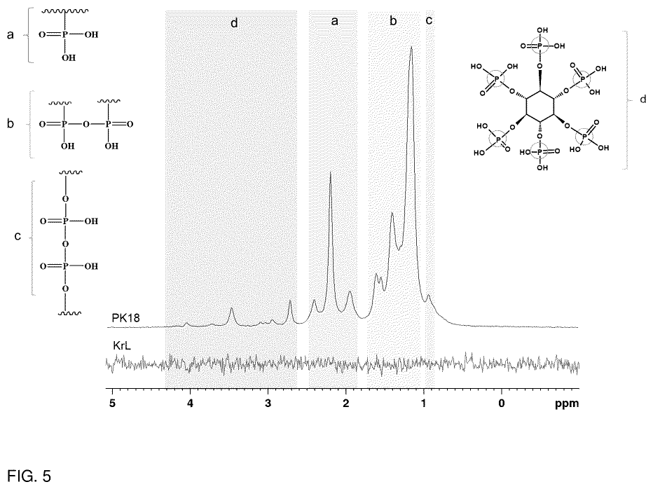

The ³¹P NMR spectra of KrL and PK 18 are shown in FIG. 5. There is no peak that can be characterized for KrL, inferring that KrL did not have any phosphorous containing groups. Based on previous studies, the phosphorous groups of PHA were assigned to four different peaks at 1, 0.5, 0, and −0.8 ppm in the ³¹P NMR, [53]. It is worth noting that the phosphorylation of lignin can happen in three different ways: on aliphatic, phenolic, and carboxyl hydroxy groups. In addition, esterification reactions and crosslinking can take place between phosphate and hydroxyl groups. Because of the esterification, a chemical shift can occur [54, 55]. Phosphate groups on PHA can show different crosslinking (a, b, and c) that were labeled in FIG. 5 and the mechanism for this reaction can occur on both intra-chain and inter-chain that is reported in FIG. 1b [56]. According to the results from qualitative ³¹P NMR, the intensity of two peaks, a and b, are high, which demonstrates that the modification mainly occurred on the intra-chain routes [56]. Accordingly, it can be concluded that PHA reacted with the hydroxyl groups of KrL and showed two types of crosslinking, a and b crosslinking, more than c type.

### Example 3: HSQC Analysis

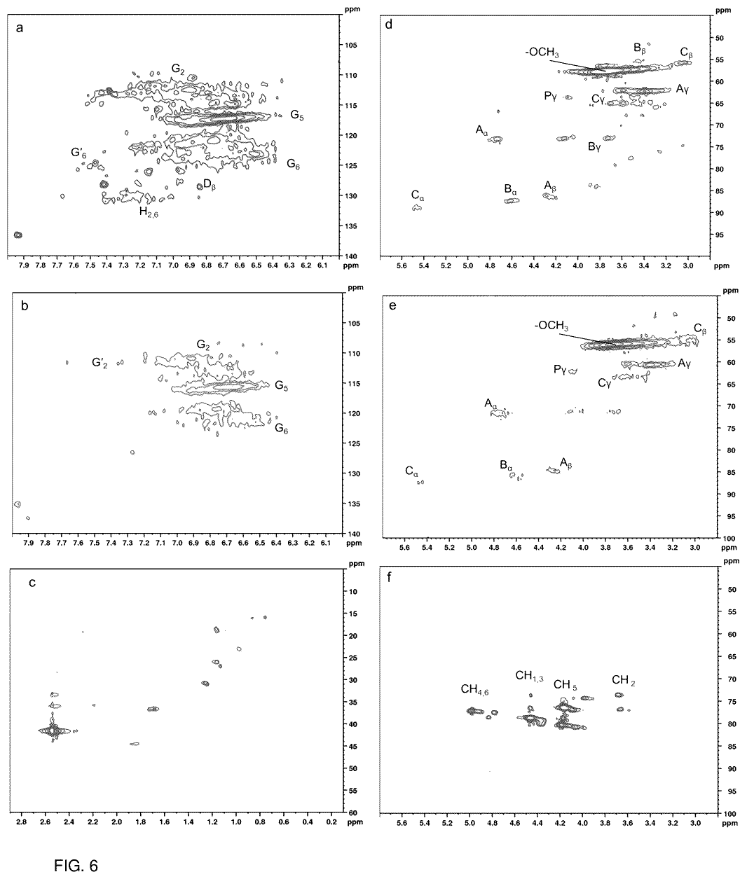

HSQC-NMR (2D) was used to understand the changes in the structure of lignin, and the ¹H-¹³C HSQC spectra of KrL and PK18 copolymer are displayed in FIG. 6. Also, the detailed structures of signal assignment of each bond of aromatic (δ_{C}/δ_{H} 100-140/6.1-7.9), aliphatic (δ_{C}/δ_{H}45-100/3-5.6) and side chain (δ_{C}/δ_{H} 10-60/0.2-2.8) [57, 58]. In the aromatic region, C type structure appears in both KrL and PK18, implying that no degradation of this unit happened after modification [59]. The large area in PK18 sample is for C—H in —OCH₃ (methoxy) that is in the aliphatic region (δ_{C}/δ_{H} 57.3/3.7). Two linkages of By (δ_{C}/δ_{H} 72.7/3.7-4.1) and B_{β} (δ_{C}/δ_{H} 55/3.2H) disappeared and cleaved after modification in PK18, which can be attributed to the crosslinking or polycondensation of hydrogen of these linkages during modification [60].

Due to the proton transferring effect of many aromatics' groups on lignin backbone, the aromatic region does not show any correlation in the HSQC. This effect is stronger when the sample was prepared with D₂O solvent, due to its high proton exchange facilitation, which increases the typical widening found in the resonances of exchangeable protons, such as hydroxyl groups [61]. PK18 is more soluble in D₂O, however, a more detailed study about phosphorus groups was conducted in D₂O owing to the fact that these groups are not detectable in DMSO solvent due to the high polarity and lower solubility [65]. FIG. 6f shows the presence of new linkages of lignin with PHA based on the four different protons and their correlation with carbons on PHA structure [62]. An HSQC graph of PHA is showed that linkages in the aliphatic region of KrL (δ_{C}/δ_{H} 75-85/3.5-5) were not detectable when the sample is prepared in DMSO because of the high negative charge density around the nucleus, the high opposite magnetic field appears around the copolymer, which will have a great shield and no linkages in this region. Findings show that the skeletal structure of lignin was preserved during phosphorylation, which might be attributed to the moderate preparation technique [63]. FIG. 6f shows the correlation of PK18 sample, which was prepared in D₂O. This figure confirms the presence of PHA that was not detectable in DMSO.

### Example 4: FTIR Analysis

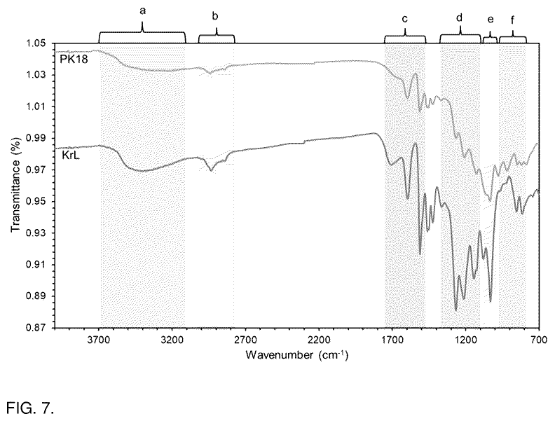

The FTIR spectra of KrL and PK18 are shown in FIG. 7. The characteristic bands in the KrL were comprehensively determined in previous studies [64]. The O—H aliphatic and aromatic stretching vibration groups show a broad transmittance band at 3400 cm⁻¹ (region a). After phosphorylation, the band intensity decreased, which can prove the attending of these O—H functional groups to phosphorus groups in the phosphorylation reaction. Aliphatic C—H stretching vibration of methyl and methylene groups showed transmittance bands at around 2930 cm⁻¹ and 2830 cm⁻¹ (region b). Phenylpropane monomer bands in KrL are established at 1591 cm⁻¹, 1510 cm⁻¹, and 1450 cm⁻¹, which are assigned to the stretching vibrations of the C—C bonds. However, the intensity of these peaks decreased after modification (region c). Both ether bands of C—O—C and stretch vibration of C—O were assigned to the groups of bands at 1280 cm⁻¹, 1200 cm⁻¹, 1120 cm⁻¹, and 1030 cm⁻¹ (region d). Phosphate moieties do not show intense bands in the IR spectroscopy [65]. However, minor alterations in the 1250 cm⁻¹ and 1300 cm⁻¹ belong to P═O. After phosphorylation, the appearance of three new bands proved that KrL was modified successfully by the PHA. These bands are PO₄³·, P—O—C aliphatic, and the P—O stretching band (region f), which are attributed to 990 cm⁻¹, 960 cm⁻¹, and 850 cm⁻¹, respectively [66, 67]. In the region f, two bands of bending and stretching are assigned for P—O—P, which can be determined in 760 cm⁻¹ and 810 cm⁻¹, respectively [68]. The P—O bond in PK18 overlapped with the aromatic C—O—C structure, which shifted the band from 1120 cm⁻¹ to 1020 cm⁻¹ in the C—O stretching of guaiacyl group of KrL (region e) [69]. All these changes in FTIR bands confirm that KrL was modified with phosphorous groups on phenolic, aromatic, and carboxylic hydroxy groups for generating PK18.

### Example 5: XPS and ICP-AES Analyses

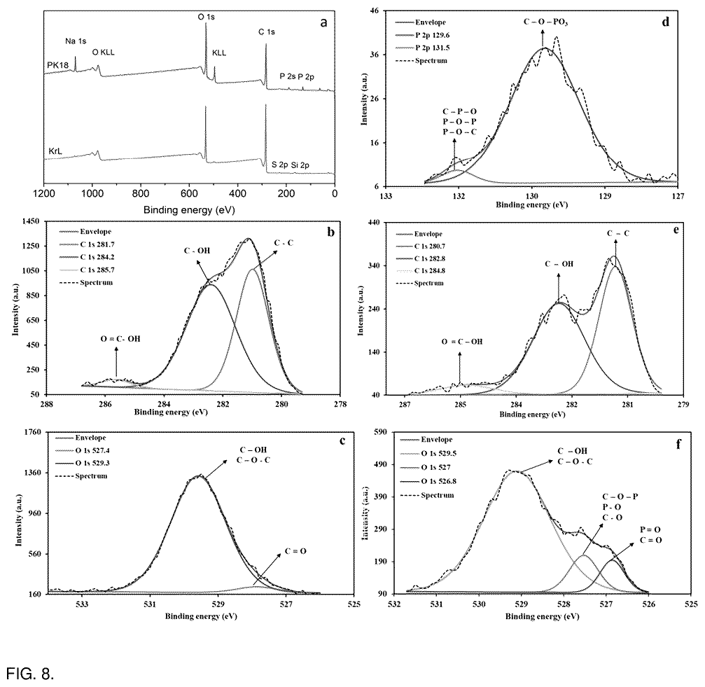

The chemical composition of the samples were analysed by X-ray photoelectron spectroscopy. The wide XPS spectra of KrL and PK18 are shown in FIG. 7a. These graphs showed two major peaks corresponding to C 1s and O 1s. In the wide spectrum of KrL, two signals are assigned for S 2p and Si 2p signals, which remained from the pulping process [70]. The presence of two new peaks in PK18 were attributed to the phosphorus molecules present after modification with PHA [71]. These peaks were found at 134.5 eV and 199 eV, which are assigned for P 2p and P 1s, respectively. From FIG. 8d, two new bonds in PK18 (C—O—PO₃, and C—P—O) prove that the reaction occurred via polycondensation with hydroxyl groups on the KrL, echoing the results obtained by ³¹P NMR. The phosphorous content of the samples was also determined from the XPS and ICP-AES data. The phosphorous group content increased from 0 wt. % to 7 wt. % after the modification of KrL with PHA. As noted herein, the amount of P content from both ICP-AES and XPS are approximately the same. The Fitted C 1s, O 1s, and P 2p spectra for both KrL and PK18 are shown in FIGS. 8 (b-f). According to C 1 s spectra and the result of mass concentration, three major peaks are shown in KrL at 281.1 C—C, 284.2 C—OH, 285.7 O═C—OH eV with mass concentration of 42.44%, 55.2%, and 2.35%, respectively. After modification, the C—C bond increased to 48.41%, which is related to the PHA that was covalently bonded to the lignin backbone. There is a decrease in the mass concentration of C—OH and O═C—OH from 55.21% to 51.04% and from 2.35% to 0.55% after phosphorylation, respectively. There is a decrease in the C—OH bond that leads to increase in the P bond.

In FIG. 8d, two new bonds in PK17 (C—O—PO₃ and C—P—O) proved that the reaction happened via polycondensation with hydroxyl groups on the KL, echoing the results verified by ³¹P NMR analysis. The phosphorous content of the samples was also determined from the XPS and ICP-AES data. The phosphorous group content increased from 0 wt. % to 7 wt. % after the modification of KL with PHA. As noted, the amount of P determined in both ICP-AES and XPS results is similar.

One strong peak at 527.4 eV was observed in the fitted 01s spectra for KrL and PK18, which corresponds to C—OH and C—O—C with 96.49% mass concentration that dropped to 81.31% after phosphorylation. There is an increase in the intensity of the C═O peak at 526.8 eV, which is due to overlapping of the new bond of P═O with this region. According to relevant studies, the formation of the C═O group and P═O in the phosphate group appeared at the same binding energy in the spectrum [72, 73]. This overlapping is attributed to the increase of these bands from 3.51% to 7.93%. The appearance of the C—O—P bond in the oxygen graph after modification at 527 eV is evidence of modification and polycondensation in the form of phosphorylation.

Fitted P 2p spectrum shows one main intense peak at 129.6 eV for C—O—PO₃, which was the characteristic of phosphorus in both polyphosphates and phosphates, and one small shoulder peak at 131.5 eV for both C—P—O and P—O—P [74]. The evidence demonstrates that the —PO₃ group replaced a part of the aliphatic hydroxy, phenolic hydroxy, and carboxylic groups on the KrL structure through the nucleophilic reaction and also demonstrates success in the reaction.

### Example 6: Mechanism of Reaction

The mechanism of reaction was proposed in FIGS. 1a and 1b. The reaction occurs in two repetitive steps: first, phosphorous anhydride is formed with the elimination of water by a polycondensation reaction, and second, the phosphate atom leads to electron transfer from the oxygen in PA to the hydrogen of hydroxyl in the KL to form a new ester bond on the KL (FIG. 1a) [35]. The appearance of new peak that related to phosphorous groups at ¹H NMR in the range of 4-4.7 ppm, C—O—PO₃ and C—P—O bonds in XPS at 130 eV and 132 eV, and PO₄³⁻, P—O—C aliphatic, and the P—O stretching band at 990 cm⁻¹, 960 cm⁻¹, and 850 cm⁻¹, in FTIR, respectively, confirms the reaction between KL and PHA. Moreover, quantitative ³¹P NMR results approved the reduction of hydroxyl groups of KL after modification. Phosphate groups on PHA covalently bonded with different crosslinking (a, b, and c). This reaction can occur on both intra-chain and inter-chain as shown in FIG. 8b [58, 99]. According to the results from qualitative ³¹P NMR (FIG. 5), the intensity of two peaks, 4a and 4b, is high, confirming that the modification mainly occurred on the intra-chain routes [48]. It can be concluded that PHA reacted with the hydroxyl groups of KL and exhibited two types of a and b crosslinks that were stronger than the c type (FIG. 5).

### Example 7: Thermal Properties

### TGA Analysis

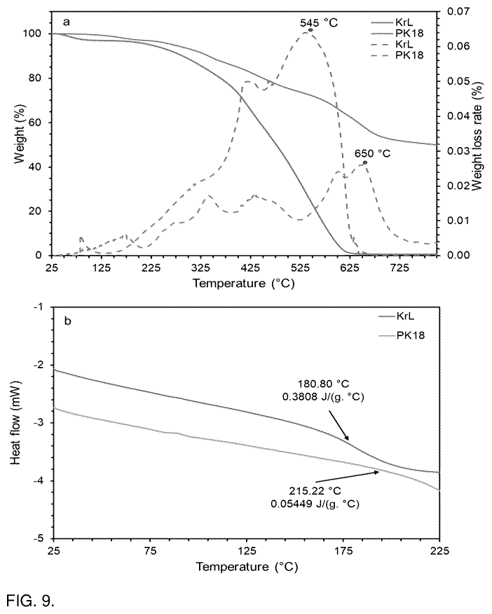

The thermal behavior of the KrL and PK18 was evaluated by thermogravimetric analysis (TGA) (FIG. 9a and Table 8). The decomposition of lignin is divided into three main stages: the initial slight weight loss in the range of 25-100° C. is because of the evaporation of moisture, CO, and CO₂. The weight loss between 175° C. and 550° C. is attributed to the degradation of aromatic rings and C—C linkages, such as C—C and β-β in KrL. The final weight loss at >550° C. was less and related to the decomposition and degradation of organic materials and carbonization [75, 76]. After moisture removal from KrL, the temperature at which 5 wt. % lost occurred (T_{d}), increased from 202±2° C. to 262±2° C. after modification. Tₒₙₛₑₜ in the TGA curve is the temperature at which the baseline from the point that started to deflect. This temperature for KrL and PK18 is 260±2° C. and 300+2° C., respectively, implying that phosphorous groups moved the temperature about 40° C. higher. By introducing the phosphorus group to KrL, the maximum decomposition temperatures (Tₘₐₓ) increased from 545° C. to 650° C., and the weight loss rate decreased from 0.064 wt. %° C.⁻¹ to 0.026 wt. %° C.⁻¹.[77]. It is also seen that KrL did not remain at >620° C., while 65 wt. % of PK18 remained. At 800° C., the char yield for PK18 was about 50 wt. %, indicating the improved thermal stability of PK18. [78,79]. XPS analysis was carried out to analyze the element (C, O, and P) bonds, functional groups, and components of the PK18 char residue after combustion in TGA at four different temperatures: 220° C., 320° C., 600° C., and 800° C. This analysis measured the percentage of bonds that break and that remain at the different temperatures. The mass percentage concentration of C decreased from 60% to 15.12% when the temperature was changed from 25° C. to 800° C., which proves char formation with carbon. However, after burning the sample, there is an increase in the P element from 7% to 26.86%, which works as a flame retardant in high temperatures. The O 1s mass percentage concentration showed that C—O—H and C—O—C decreased from 81.31% to 15.22%, while there is an increase in C—O—P, O—P, O—C C═O, and P═O bonds. The mass concentration percentages of bonds for P 2p showed that by increasing the temperature, the mass concentration of bond C—O—P═O3 decreased. The important bond, which remains in char for phosphorous elements at 800° C. as a flame retardant is C—P—O and P—O—P. More crosslinking will increase the P—O—P bond, which in turn will increase Tₘₐₓ in TGA.

### DSC Analysis

The differential scanning calorimetry (DSC) curves are shown in FIG. 9b. Polymer molecular weight, crosslinking degree, branching degree, and chain length can all affect Tg due to their impacts on polymer mobility [78-80]. As reported in Table 7, the T_{g} for KrL was found at 180.80° C., which increased to 215.22° C. after modification. The presence of P element after modification and crosslinking of hydroxyl groups on the KrL with the active sites of PHA all contribute to the increase T_{g}. In addition, PK18 has lower heat capacity (Cₚ) than KrL, 0.0544 J (g. ° C.)⁻¹ and 0.3808 J (g. ° C.)⁻¹, respectively. This lower heat capacity is due to crosslinking, less mobility, and resistance to breakdown [81,82]. In addition, it can also be claimed that the presence of inorganic compounds can increase the T_{g} and decrease the C_{P} [83].

### Example: Flame Retardancy Performance

### Limiting Oxygen Index

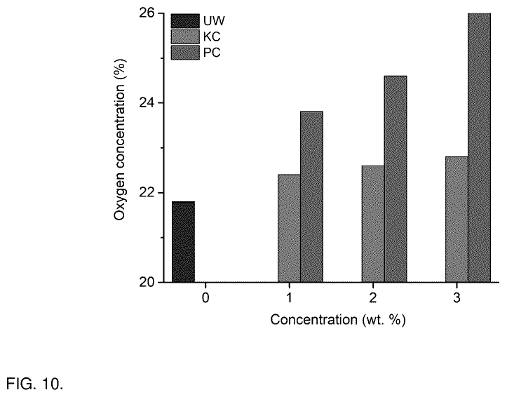

Flame retardancy of materials is commonly determined by the limiting oxygen index (LOI), and the results are listed in FIG. 10. Generally, with the increase in LOI values, the flame retardancy of the sample increases. As shown in FIG. 10, the LOI value of uncoated wood (UW) was 21.8%, implying that following a small ignition, it will burn quickly. Different concentrations (1, 2, and 3 wt. %) of KrL (KC1, KC2, and KC3) were used to coat the wood, respectively. The results show that by increasing the KrL concentration, the flame retardancy was improved due to the long side alkyl chains in lignin benzene ring and aromatic structure with abundant polyphenol structures, which can accelerate the char formation [84]. In the past, lignin has been used as a fire retardant for polymers [85]. Phosphorus can be used as an inorganic reagent that can decrease the flammability of materials in both gas and condensed phases of materials [86]. Upon increasing the concentration of PK18 to 1, 2, and 3 wt. %, the LOI value increased for the samples of PC1, PC2, and PC3, respectively. Flame retardancy behavior is mostly related to the concentration of phosphorus solution used for coating. Increasing the amount of PK18 on the wood coating applications elevated the phosphorus content of the coating layer on the wood material, which can delay the transfer of heat, block the diffusion of flame efficiently, and finally provide a higher flame retardancy [87].

### Smoke Density Analysis

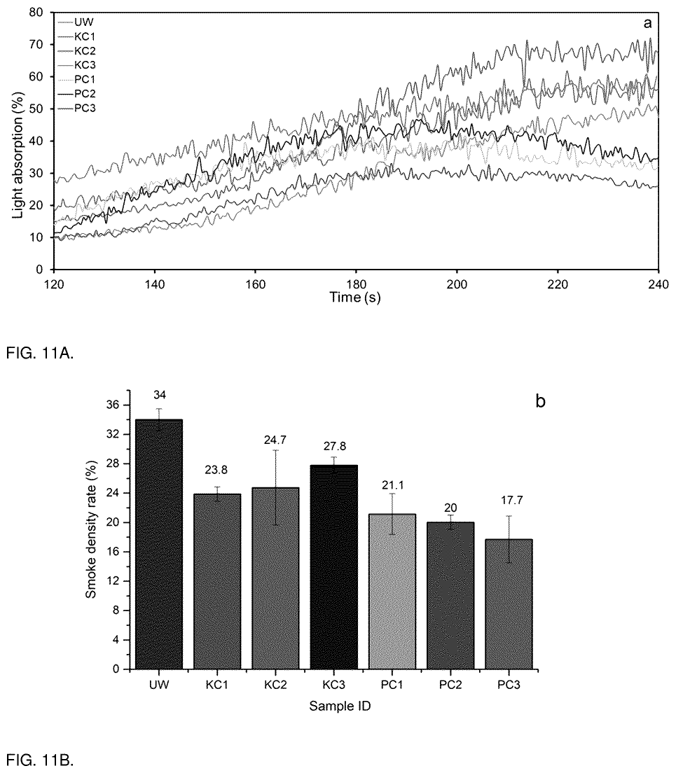

For this analysis, wood was coated with different concentrations of KrL and PK18 and then burned in a smoke density detector. As shown in FIG. 11a, the light absorption of the uncoated wood (UW) was elevated to 50% of light absorption and 34% smoke density rate in 240 s. Generally, KrL can be used as a flame retardant in biopolymers [88], thus the introduction of KrL to wood will affect the flame retardancy performance of the wood. By coating the wood with different concentrations of KrL, the SDR (smoke density rate) value decreased to 23.8%, 24.74%, and 27.8%, respectively. However, the light absorption percentage increased to a certain degree, but then dropped because of the char formation that decreased the smoke density. The introduction of 1, 2, and 3 wt. % PK18 reduced the light absorption and SDR value. The PK18 coated wood indicate a decrease in smoke production after 200 seconds, mainly because phosphorus compounds start to decompose and the protective char layer of phosphorus-carbon begins to form. This protective layer could hold the flammable gases from being released from the inner layers and keep the heat away from unburned wood layers [89]. PC3 shows the lowest light absorption and SDR value of 17.7%, and this value is 16% lower than UW. The results of the smoke detector confirms that the introduction of PK18 can increase the production of char residues and postpone the release of pyrolysis gases, which is supported by the TGA test. The protective mechanism of PK18 can occur both chemically and physically in both the gas phase and the condensing phase. During combustion, triphenyl phosphate and triphenylphosphine oxide can break down into small radicals like HPO·, PO₂·, PO·, and P₂·. Because of ignition, these phosphorus radicals can work as a cleanser for H· and OH· radicals released in the gas phase [90]. By decreasing the number of hydrogen and hydroxy radicals, exothermic processes will interrupt repressed combustion and lead to less smoke release [91, 92,24].

### Example 9: SEM

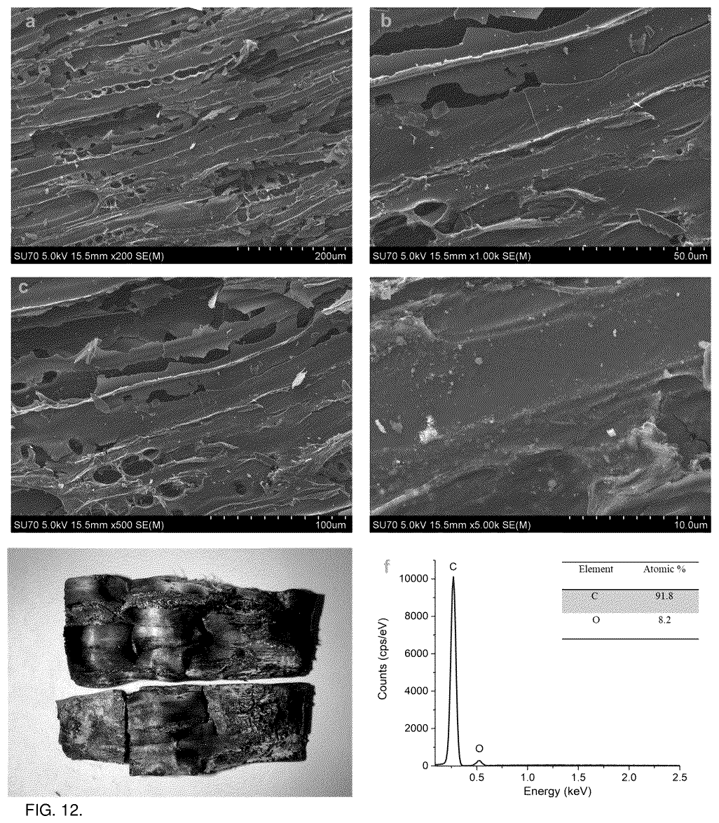

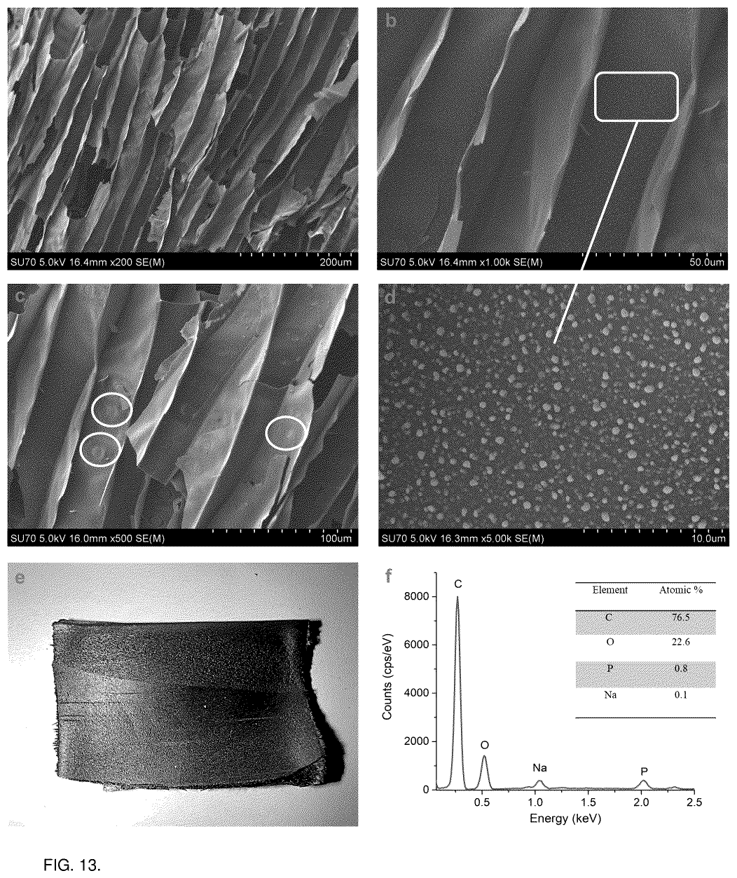

The influence of phosphorylated lignin on the surface morphology of coated wood is generally determined by investigating char residues after smoke detector analysis. The results provide evidence for the elemental composition of phosphorus crystals, char residue formation, filled pores structures, and gaps and cracks in wood after burning, which produce a physical protection shield to interrupt the trancing of gas penetration (oxygen), fuel, and heat flow during combustion [93]. FIGS. 12 and 13 show char morphology after completing the combustion of UW and PC3, respectively. The spherical pores in FIG. 12 were caused by the gas released during combustion in UW, while these pores are compact in PC3. FIGS. 13c and 13d show blocked pores because of phosphoric acid production during thermal degradation that leads to increased dehydration and carbonization of PK18 to form a char and phosphorous crystals which penetrate the pores and block them [94]. FIG. 13d shows the phosphor crystals after combustion. A layer of char covered PC3 after burning, which is due to the dehydration of PK18 and wood by phosphorous groups [95]. However, FIGS. 12c and d show some broken structures in the UW, which can be caused by release of non-flammable gases. In addition, EDX observation indicated the presence of phosphorous elements after burning of PC3 (FIG. 13f). Phosphorus is an inorganic element that, after decomposition, will produce radicals to accelerate char forming as a protection layer and restriction for more degradation [96]. The digital pictures of UW and PC3 were reported in FIGS. 12e and 13e. These results indicated that PK18 coating solution works as a protection layer to resist burning and cracks in wood.

### Example 10: Flame Retardant Performance

The flame retardancy of materials is commonly determined by the limiting oxygen index (LOI), and the results are listed in FIG. 10. Generally, with the increase in LOI values, the flame retardancy of the sample increased. As shown in FIG. 10a, the LOI value of uncoated wood (UW) was 21.8%, implying that it could burn quickly with a small ignition. Different concentrations (1, 2, and 3 wt. %) of KL (KC1, KC2, and KC3) were used for coating the wood species, respectively. Upon increasing the concentration of PK17 to 1, 2, and 3 wt. %, the LOI value increased to 23.8%, 24.6%, and 26.0% for the samples of PC1, PC2, and PC3, respectively. Moreover, filter paper coated with 3 wt. % PK17 demonstrated an increment in the LOI from 18% to 21%. Jiang et al. found that 10 wt. % of N, N-biguanide-diethyl phosphonic acid can increase the LOI value of filter paper by >10%.⁹⁷

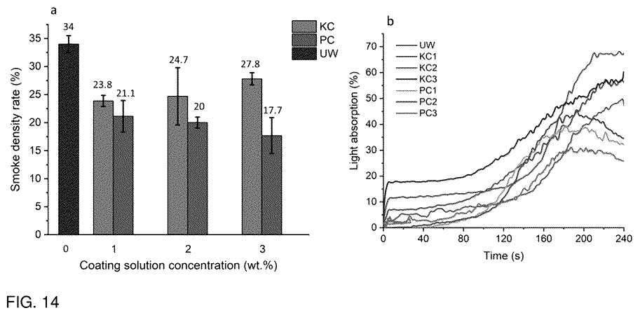

As shown in FIGS. 14a and b, the smoke density rate (SDR) in 240 s and light absorption of the uncoated wood (UW) were 34% and 50%, respectively. Generally, introducing KL to wood will affect wood species' flame retardancy. Coating wood with 1, 2, and 3% KL decreased the SDR value to 23.8%, 24.7%, and 27.8%, respectively. The introduction of 1, 2, and 3 wt. % of PK17 reduced the light absorption to about 30%. The PK17-coated woods indicated a decrease in smoke production after 200 seconds, mainly because of the protective char layer of phosphorus-carbon.98 Interestingly, the light absorption value peaked at around 180 s and subsequently declined since less smoke was released due to the char formation acting as a protective layer to lower the smoke density. PC3 (coated wood with 3 wt. % of PK17) showed the lowest light absorption of 17.7% (i.e., 16% lower than UW).

### Example 11: Morphological Study of Burned Wood

The influence of phosphorylated lignin on the surface morphology of wood is generally determined by investigating char residues with SEM after smoke detector analysis [100]. The spherical pores of some broken structures show the released gas caused by the combustion of UW, while these pores are compact in PC3 [101]. FIG. 13a-d shows the blocked pores because of phosphoric acid production during thermal degradation. This would lead to increased dehydration and carbonization of PK17 to 20 form char and phosphorous crystals to penetrate the pores and block them [96, 102]. FIG. 13d shows the phosphor crystals after combustion. A char layer covered the PC3 after burning due to phosphorous groups' dehydration of PK17 and wood [97]. In addition, EDX observation indicated the presence of phosphorous elements after burning PC3 (FIG. 13f).

### Example 12: The Mechanism of Flame Retardancy

FRs are employed to interrupt the combustion process in two ways: they create a dense char that shields the substrate from combustible gases (i.e., oxygen) and heat (condensed phase mechanism), and they generate radical scavengers that can halt the chain propagation of combustion reaction (vapor phase mechanism) [103]. The flame retardancy of PK17 can happen in both gas and condensed phases, chemically and physically. Phosphorus is an inorganic element that will produce radicals after decomposition to accelerate char formation as a protective layer from heat degradation [98]. During the combustion, triphenyl phosphate and triphenylphosphine oxide can break down into small radicals, such as HPO·, PO₂·, PO·, and P₂· [104]. Because of ignition, these phosphorus radicals can function as an adsorbent for H· and OH· radicals released in the gas phase needed for ignition. A decrement in these radicals will reduce the flame [92].

In the condensed phase, phosphorus compounds start to decompose, and the protective char layer of phosphorus-carbon begins to form [81]. This protective layer could hold the flammable gasses released from inner layers and keep away the heat from unburned wood layers [91. 95].

For a better understanding of how PK17 works as a flame retardant fundamentally, XPS analysis was carried out on the samples collected from TGA after treatment at four different temperatures (220, 320, 600, and 800° C.). The mass concentration of P 2p increased from 7% at 25° C. to 26.9% at 800° C. Also, the C—C bond concentration remained almost the same (about 42%), but there was a decrease in the mass concentration of C—OH and C—O—C bonds from 81.31 to 15.22%. However, there was an increment in P—O, C═O, and P═O bonds from 3.51% to 49.49%. These results confirmed that P and C remained as by-products of burning in the form of —P═O, C═O, C—O—P, P—O, P—O—P, and C—P—O, while oxygen was released. Also, the mass concentration of C—P—O and P—O—P increased from 4.36% to 70.33% [105]. Wang et. Al. argued that thermal oxidation resistance can be confirmed by an increment in C═O, which exhibits a thermal flame retardancy mechanism [110].

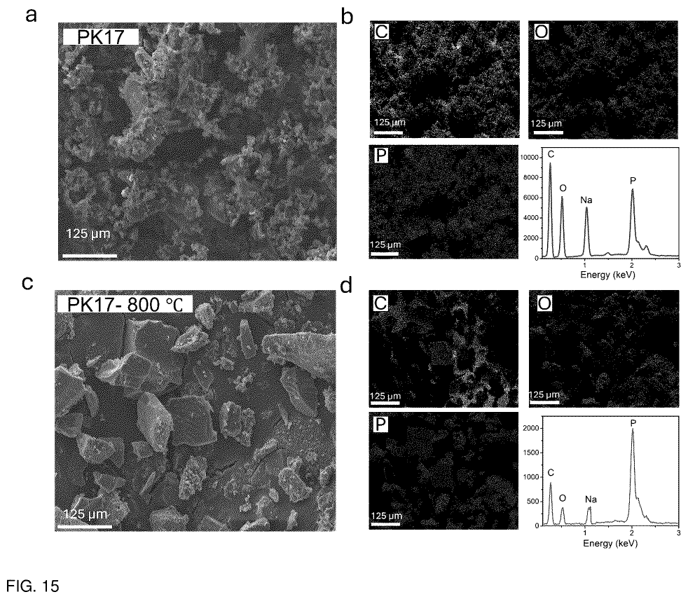

The deep analysis was carried out on a microscale by SEM, EDS, and EDX for PK17 before and after combustion at 800° C. It was found (FIGS. 15a and 15c) that the morphology of PK17 changed from a regular structure to irregular with some crystal structures [107], which was confirmed by SEM in coated wood after burning (FIG. 15d). In addition, the homogenous distribution of C, P, and N elements in the PK17 and KL sample before and after combustion in the EDS images (FIG. 15) was confirmed. Still, the intensity of the phosphorus element increased after combustion for PK17. Flame retardancy is mainly related to the concentration of phosphorus that can delay the transfer of heat, block the diffusion of flame efficiently, and increase oxygen demand for burning, inducing a more efficient flame retardancy (FIGS. 10 and 14b) [108].

To understand how PK17 would function as a flame retardant, the SEM and EDX images of PC3 samples after combustion were analyzed in detail. The results (FIG. 13) provide evidence for the elemental composition of phosphorus crystals, char residue formation, filled porous structures, gaps, and cracks in wood after burning. These results imply that PC3 acted as a protection shield to disrupt the penetration of gas (oxygen) and heat flow during combustion [91]. In addition, the char formation would work as a protection layer that would decrease smoke release, leading to a lower smoke density rate and light adsorption (FIG. 10).

The performance and reaction route of phosphorylated lignin products were compared with other phosphorylated lignin products in Table 9. Our sample, a pioneering biomaterial, sets itself apart by being free from solvent (water base) and bio-phosphorus reagent (PHA) while exhibiting outstanding high heat resistance and flame retardancy. Unlike conventional materials that are listed in Table 9, made of oil-derived chemical reagents and under harsh and environmentally unfriendly conditions, our biomaterial was produced using environmentally friendly reagents, a water-based reaction at room temperature, ensuring a safer and more sustainable approach. The elimination of solvents not only reduces the environmental impact but also minimizes potential health hazards associated with their use. Additionally, our biomaterial's heat resistance is outstanding, offering enhanced heat resistance. This combination of solvent-free processing and excellent heat resistance with high thermal performance underscores the material's potential in advancing eco-friendly and high-performance applications. Theoretically, other types of lignin, e.g., alkali, lignosulfonate, organosolv, may be used for reacting with PHA in a similar manner as they all have OH functional groups.

### Example 13: Material and Methods

### Materials

Softwood kraft lignin (KrL) was obtained from FPinnovations, Hinton, Alberta, which was extracted via Lignoforce technology. Phytic acid sodium salt hydrate (C₆H₁₈O₂₄P₆) (PHA), sodium hydroxide (NaOH) (≥97%), sulfuric acid (H₂SO₄) (98%), deuterium oxide (D₂O-d₆) (99.9%), dimethyl sulfoxide-d₆ (DMSO-d₆) (99.8%), 3-(Trimethylsilyl)propionic-2,2,3,3-d4 acid sodium salt tetramethylsilane (TMSP) (≥98.5%), cyclohexanol (99%), 3-2-Chloro-4,4,5,5-tetramethyl-1,3,2-dioxaphospholane (CDP) (95%), chromium(III) acetylacetonate (97%), sodium azide (NaN₃) (≥99.5%), and poly (diallyl dimethylammonium chloride) (PDADMAC) (100-200 kg/mol) were all purchased from Millipore Sigma, Oakville, Canada. The 1000 g/mol cut-off of the dialysis membrane made of cellulose acetate was purchased from Spectrum Labs. Pinewood (untreated, ALEXANDRIA, made in Canada) was purchased with the two different sizes and barcodes (00010-3196C for LOI, 00015-30096C for smoke density) from Canadian tire Inc, Canada, Thunder Bay store.

### Modification of Lignin Via Phosphorylation

Phytic acid sodium salt hydrate (PHA) was used as the phosphorylating reagent. In each experiment, around 1 mol (1.5 g) of KrL and different molar ratios of PHA/lignin were used. For the phosphorylation of lignin, KrL was dispersed in deionized (DI) water (Concentration 25 g/L), and the pH of the mixture was adjusted to 12 by adding 1 M NaOH. The mixture was stirred for 24 hours at room temperature to complete the deprotonation. Different concentrations of reagent (PHA) were dispersed in 30 mL of deionized water and then added to the KrL solution to make different ratios of PHA/KrL. Afterwards, the mixture was transferred to a three-neck round-bottom flask in a water bath with a reflux condenser. Upon completion, the reaction mixtures were cooled to room temperature, neutralized with 1 M H₂SO₄, and purified for 48 hours via dialysis membrane in DI water to remove unreacted reagents. The product was then dried at 60° C. in the oven. The product of this reaction, phosphorylated lignin, was denoted as PK. This experiment was repeated under different conditions of (KrL:PHA, 1: 0.02, 0.06, 0.16, 0.2, 0.3, 0.4 mol:mol), pH, solvent types (DI water and urea), time (20-240 minutes), and temperature (20-80° C.) to optimize the reaction. The pH was adjusted in three different conditions (strategies were discussed above), with 1 M NaOH solution and 1 M HCl. A control sample (CK) of KrL was produced following all steps outlined in the polymerization, pH adjustment, purification, and drying procedures in the absence of PHA.

### Characterization of Phosphorylated Lignin

### Charge Density, Solubility, Elemental Analysis, and Molecular Weight Measurement

The charge density of PK samples was determined by a Particle Charge Detector (PCD 04, BTG Mütek GmbH, Germany) using a 0.005 mol/L PDADMAC solution as the titrant. For assessing the charge density of the samples, 1 wt. % of the sample was stirred at 200 rpm for 24 h at 25° C. Then, the prepared suspensions were centrifuged at 1000 rpm for 5 min to separate soluble and insoluble parts. Afterward, 1 mL of the soluble portion of the samples was titrated against 0.005 mol/L PDADMAC solution to determine the charge density of the samples. Solubility analysis was measured by adding 0.2 g of lignin derivatives to 19.8 mL of deionized water. The suspensions were shaken in a water bath (Innova 3100, Brunswick Scientific, Edison, NJ, USA) for 12 h at 200 rpm and 25° C. Next, the prepared suspensions were centrifuged at 1000 rpm for 5 min. Then, 5 mL of the soluble part was taken and added to an aluminum tray to dry in a 105° C. oven. Data points were collected and weighed before and after drying the trays, and it was repeated three times. The solubility of the samples was calculated considering the collected, dried weight of the insoluble samples with standard deviations.

The organic elements, CHNS, of the samples was analyzed using an organic Elemental Vario EL following the combustion method. The samples were first oven dried at 60° C. for 24 h, then 0.02 g was transferred into the carousel chamber of an elemental analyzer. Carbon, hydrogen, sulfur, and nitrogen content of the samples was assessed via combusting the samples at 1200° C., and the gases were reduced for analysis.

The molecular weight (MW) of samples was measured via a gel permeation chromatography (GPC, Malvern GPCmax VE2001 Module+Viscotek TDA305 with multi-detectors) with the columns of PolyAnalytic 206 and PAA203, by dissolving 50 mg of sample in 10 mL of 0.1 M NaN₃. The prepared solution was filtered by a 0.2 μm filter and analyzed by a standard method explained in the literature [97]. The temperature of the column and detector were set at 35° C. with the flow rate of 0.7 mL/min and 70 μL of each sample injection to the column, then the MW was detected by the RI detector.

¹H NMR, HSQC (2D), and ³¹P NMR Analysis

The chemical structure of lignin samples was characterized by proton nuclear magnetic resonance (¹H NMR) and the two-dimensional heteronuclear single-quantum coherence NMR (2D-HSQC) was characterized using a Bruker Advance spectrometer at room temperature. The NMR samples were prepared by dissolving approximately 75-85 mg of KrL in 1 mL of DMSO-d₆ and PK18 in D₂O-d6 and stirred at 200 rpm for 24 hours, and 1 hour before the analysis, 5-6 mg internal standard (TMSP) was added.

³¹P NMR spectroscopic was carried out in both quantitative and qualitative analyses. Quantitative ³¹P NMR analysis assessed the content of phenolic hydroxyl, aliphatic hydroxyl, and carboxyl groups of KrL and PK18, i.e., the PK produced under the optimized conditions [98]. First, 70 mg of sample was dissolved in 1 mL pyridine/CDCL₃ (1.6:1) mixture, then 200 μL of 2-chloro-4,4,5,5-tetramethyl-1,3,2-dioxaphospholane as the phosphorylation reagent was added to mixture in the presence of 70 μL of cyclohexanol as the internal standard. The quantitative data of ³¹P NMR was collected at a pulse angle of 90°, room temperature, 0.65 acquisition time, and 25 s pulse delay with spectral parameters of a decoupling pulse sequence. The spectra were obtained using nuclear magnetic resonance spectroscopy (AVANCE NEO-1.2 GHz, Bruker Corporation, USA) with 1024 scans per sample at 25° C., a 0.6 s acquisition time, a 90° pulse, and 5 s of relaxation delay time. Qualitative ³¹P NMR was conducted by dissolving 80 mg of KrL in DMSO-d₆ and PK in D₂O-d6. The spectra were collected at room temperature, with 256 scans, 0.72 s acquisition time, a 2 s pulse delay, a 30° pulse width, and a relaxation time of 2 s with spectral parameters of a decoupling pulse sequence. The ¹H-¹³C HSQC measurements were performed under the following conditions: a 90° pulse width of 48.17 μs, relaxation delay of 1.5 s, and an acquisition time of 0.15 s; 16 scans were performed. The ¹H-³¹P HMBC measurements were performed under the following conditions: relaxation delay of 7 s, a 90° pulse width of 13.5 μs, 16 scans, and an acquisition time of 0.36 s, at 25° C. were performed. Top Spin 4.0.9 software was used to process NMR data points and spectra (2020 Bruker BioSpin GmbH).

### FTIR Analysis

The FTIR analysis of KrL and PK samples was carried out to monitor the chemical structures of the samples using Bruker Tensor 37 instrument (Germany, Germany, ATR accessory). For each analysis, a 50 mg powder sample was used, which was previously dried at 60° C. oven for 24 h. Samples were analyzed at the resolution of 4 cm⁻¹ with spectral width ranging between 4000 to 500 cm⁻¹ and 32 scans in adsorbent mode.

### ICP-AES and XPS Analysis

Phosphorus content of the samples was determined by an inductively coupled plasma spectrometer (ICP-AES). In this method, a representative sample from a homogenous and ground solid is digested in a CEM Mars Xpress microwave oven using I-CHEM glass vessels with nitric and hydrochloric acids. Once the digestion program is complete, the samples were diluted to 40 mL with Type I DDW. The sample digests were analyzed by the ICP-AES Varian), the modified EPA Method 3051.

XPS spectra were recorded using about 10 mg of a dried sample at 60° C. The analysis was performed using a photoelectron spectrometer (XPS, Escalab 250XL+, Thermo fisher scientific, USA) with a monochromatic Al Kα X-ray source (1486.7 eV) operating at 15 kV (90 W) in a FAT mode (fixed analyzer transmission). The energy pass amount for the ROI region was 40 eV and for Survey region was 80 eV. The voltage of 284.6 eV was used for the calibration of the C is binding energy. Full-spectrum, narrow high-energy resolution spectra, elemental composition, and functional groups were assessed using an ESCape software that was operated for fitting graphs, elemental composition, functional groups binding energy, and mass concentration of bonds.

### Thermal Analysis

To investigate the thermal response of PK samples, thermogravimetric analysis (TGA) was performed. Before analysis, samples were dried in a 60° C. oven for 24 hours. Then, 78 mg of the sample were measured in a special sample holder for analysis. The analysis was performed under a nitrogen gas atmosphere in a thermal analyzer (TGA i1000, Instrument Specialists Inc.) with a gas flow rate of 20-30 μsi and 15 mL/min and heated from 25° C. to 800° C. at the rate of 10° C./min. The samples were collected at different temperatures of 220° C., 320° C., 600° C., and 800° C. for surface elemental analysis conducted by XPS.

Differential scanning calorimetry (DSC) was used to estimate the glass transition temperature (T_{g}) of KrL, and PK. In this analysis, 10 to 12 mg of dried samples were placed in hermetic Tzero® aluminum pans and loaded to a differential scanning calorimeter (DSC Q2000, TA Instruments, DE, USA) with a nitrogen gas flow rate of 50° C./min. This experiment was performed in two heating and one cooling cycle. In the first cycle, for erasing the thermal history, temperature was raised from 20° C. to 230° C., then cooled from 230° C. to 20° C. at 5.0° C./min. In the second cycle, heating cycle was performed from 20° C. to 230° C. at 10.0° C./min for the T_{g} determination. This analysis was conducted twice, and the standard deviations and average values were reported.

### Flame Retardancy Performance Analysis

For flame retardancy analysis, first the wood samples were coated with PK18 solutions. Before coating, the wood samples were washed with ethanol, rinsed with DI water, and dried at 60° C. for 2 hours. Three different concentrations of KrL and PK18 were diluted in DI water to 10, 20, and 30 wt. % concentrations. The wood samples were immersed and dip-coated in solution at 60° C. for 4 hours. After coating each sample was dried at 60° C. until the weight of the sample was unchanged.

The fire resistance behavior of coated wood samples was measured by the limiting oxygen index (LOI) analyzer (NETZSCH TAURUS INSTRUMENTS, Germany) according to ASTM D 2863 standard with the sample size of (140 mm×20 mm×10 mm) at room temperature and based on the standard samples were marked 50 mm of the wood top to the bottom. Coated samples were placed in a vertical glass column with a flow rate of 40 mm/s for the oxygen and nitrogen gas based on the standard test techniques. The length of the flame was adjusted to 20 mm. The minimum amount of oxygen that needs to ignite the sample was recorded as an LOI percentage. The static smoke releasing of coated wood with the dimension of (4.5 mm×4.5 mm×1 mm) was tested by a smoke detector instrument (Smoke Density Advanced Instruments Co., Ltd. AIC-2843) according to ASTM D2843. In this analysis, the propane gas pressure was adjusted to 42 μsi. The coated sample was placed on the square metal screen for burning, and the propane burner exposed the sample. The smoke density apparatus software was used for analysis, and data was collected based on the smoke density rate and light adsorption percentage.

Scanning electron microscopy, SEM, was carried out to provide the evidence for the effect of PK18 on wood after coting. After burning the wood samples in the smoke density analyzer, they were collected and the morphologies of char for uncoated wood (UW) and coated wood (PC3) after burning were recorded by FE-SEM; Hitachi Su-70. The scale of 200, 100, 50, and 10 μm with the voltage of 5 kV were used for recording the images. Also, the surface elements of the burned wood samples were analyzed by the energy-dispersive X-ray spectrometer (EDX) of the XPS instrument.

### Morphological Study of Burned Wood

Scanning electron microscopy (SEM) was used to analyze the surface morphology of the wood samples after the flame retardancy test. Specifically, after burning the wood samples in the smoke density analyzer, the burned samples were collected, and the morphologies of char formed on uncoated wood (UW), coated wood with KL (KC), and coated wood with PK17 (PC) were analyzed using SEM. Also, PK17 and KL before and after combustion at 800° C. by TGA were collected and analyzed by FE-SEM; Hitachi Su-70 with a voltage of 5 kV. Also, the surface elements mapping and elemental analysis of samples were carried out by energy dispersive spectroscopy (EDS) and energy-dispersive X-ray spectrometer (EDX) that were conducted in a voltage of 200 kV, which samples were coated by gold and carbon glue. Details of characterization are available in supplementary information.

While the preferred embodiments of the invention have been described above, it will be recognized and understood that various modifications may be made therein, and the appended claims are intended to cover all such modifications which may fall within the spirit and scope of the invention.

### REFERENCES

[1] E. D. Weil and S. V Levchik, “Flame Retardants in Commercial Use or Development for Textiles,” J Fire Sci, vol. 26, 2008, doi: 10.1177/0734904108089485.
[2] A. B. Morgan and J. W. Gilman, “An overview of flame retardancy of polymeric materials: Application, technology, and future directions,” Fire Mater, vol. 37, no. 4, pp. 259-279, June 2013, doi: 10.1002/FAM.2128.
[3] M. Dogan, S. Dilem Dogan, L. Atabek Savas, G. Ozcelik, and U. Tayfun, “Flame retardant effect of boron compounds in polymeric materials,” Composites Part B, vol. 222, p. 109088, 2021, doi: 10.1016/j.compositesb.2021.109088.
[4] J. De Boer and H. M. Stapleton, “Toward fire safety without chemical risk,” Science (1979), vol. 364, no. 6437, pp. 231-232, April 2019, doi: 10.1126/SCIENCE.AAX2054/ASSET/5FB6B102-67CF-4428-A3A9-3D04FF0273BA/ASSETS/GRAPHIC/364_231_F1.JPEG.
[5] I. van der Veen and J. de Boer, “Phosphorus flame retardants: Properties, production, environmental occurrence, toxicity and analysis,” Chemosphere, vol. 88, no. 10, pp. 1119-1153, August 2012, doi: 10.1016/J.CHEMOSPHERE.2012.03.067.
[6] F. Xu, L. Zhong, C. Zhang, P. Wang, F. Zhang, and G. Zhang, “Novel High-Efficiency Casein-Based P—N-Containing Flame Retardants with Multiple Reactive Groups for Cotton Fabrics,” 2019, doi: 10.1021/acssuschemeng.9b02474.
[7] L. Costes, F. Laoutid, S. Brohez, and P. Dubois, “Bio-based flame retardants: When nature meets fire protection,” Materials Science and Engineering R: Reports, vol. 117, pp. 1-25, July 2017, doi: 10.1016/J.MSER.2017.04.001.
[8] M. Ghanadpour, F. Carosio, P. Tomas Larsson, and L. Wa, “Phosphorylated Cellulose Nanofibrils: A Renewable Nanomaterial for the Preparation of Intrinsically Flame-Retardant Materials,” 2015, doi: 10.1021/acs.biomac.5b01117.
[9] K. Ahmad, H. R. Ghatak, and S. M. Ahuja, “A Review on the Valorization of Biorefinery Based Waste Lignin: Exploratory Potential Market Approach,” Environmental Science and Engineering, pp. 275-309, 2022, doi: 10.1007/978-3-030-96554-9_19/COVER/.
[10] G. Atiwesh, |Christopher, C. Parrish, J. Banoub, and T.-A. T. Le, “Lignin degradation by microorganisms: A review,” 2021, doi: 10.1002/btpr.3226.
[11] J. Garg et al., “Applications of lignin nanoparticles for cancer drug delivery: An update,” Mater Lett, vol. 311, p. 131573, March 2022, doi: 10.1016/J.MATLET.2021.131573.
[12] S. Li et al., “Antimicrobial Lignin-Based Polyurethane/Ag Composite Foams for Improving Wound Healing,” vol. 23, pp. 1622-1632, 2022, doi: 10.1021/acs.biomac.1 c01465.
[13] M. Li et al., “Lignin demethylation for modifying halloysite nanotubes towards robust phenolic foams with excellent thermal insulation and flame retardancy,” 2021, doi: 10.1002/app.52019.
[14] B. Wang et al., “New sustainable Mannich-functionalized lignin flocculants for ultra-efficiently tailoring wastewater purification,” J Clean Prod, vol. 387, February 2023, doi: 10.1016/j.jclepro.2022.135801.
[15] L. Meng, S. Chirtes, X. Liu, M. Eriksson, and W. C. Mak, “A green route for lignin-derived graphene electrodes: A disposable platform for electrochemical biosensors,” Biosens Bioelectron, vol. 218, p. 114742, December 2022, doi: 10.1016/J.BIOS.2022.114742.
[16] T. Yao et al., “Pyrolysis Kinetics of Lignin-Based Flame Retardants Containing MOFs Structure for Epoxy Resins,” Molecules, vol. 28, no. 6, p. 2699, March 2023, doi: 10.3390/molecules28062699.
[17] D. Zhang et al., “(No Title),” 2021, doi: 10.1039/d1gc01109j.
[18] H. Yang et al., “Molecularly Engineered Lignin-Derived Additives Enable Fire-Retardant, UV-Shielding, and Mechanically Strong Polylactide Biocomposites,” vol. 22, pp. 1432-1444, 2021, doi: 10.1021/acs.biomac.0c01656.
[19] L. Costes et al., “Phosphorus and nitrogen derivatization as efficient route for improvement of lignin flame retardant action in PLA,” Eur Polym J, vol. 84, pp. 652-667, November 2016, doi: 10.1016/J.EURPOLYMJ.2016.10.003.
[20] Y. Liu et al., “A facile strategy to fabricate phosphorus-free and halogen-free flame retardant polyacrylonitrile fiber based on amidoximation and Fe (III) ion chelation,” Polym Degrad Stab, vol. 203, p. 110062, September 2022, doi: 10.1016/J.POLYMDEGRADSTAB.2022.110062.
[21] Y. Guo, C. Cheng, T. Huo, Y. Ren, and X. Liu, “Highly effective flame retardant lignin/polyacrylonitrile composite prepared via solution blending and phosphorylation,” Polym Degrad Stab, vol. 181, p. 109362, November 2020, doi: 10.1016/J.POLYMDEGRADSTAB.2020.109362.
[22] Z. Xiong, Y. Zhang, X. Du, P. Song, and Z. Fang, “Green and Scalable Fabrication of Core-Shell Biobased Flame Retardants for Reducing Flammability of Polylactic Acid,” 2019, doi: 10.1021/acssuschemeng.9b01016.
[23] X. Cheng, L. Shi, Z. Fan, Y. Yu, and R. Liu, “Bio-based coating of phytic acid, chitosan, and biochar for flame-retardant cotton fabrics,” Polym Degrad Stab, vol. 199, p. 109898, May 2022, doi: 10.1016/J.POLYMDEGRADSTAB.2022.109898.
[24] X. Cheng, L. Shi, Z. Fan, Y. Yu, and R. Liu, “Bio-based coating of phytic acid, chitosan, and biochar for flame-retardant cotton fabrics,” Polym Degrad Stab, vol. 199, p. 109898, May 2022, doi: 10.1016/J.POLYMDEGRADSTAB.2022.109898.
[25] M. Barbalini, L. Bertolla, J. Toušek, and G. Malucelli, “Hybrid Silica-Phytic Acid Coatings: Effect on the Thermal Stability and Flame Retardancy of Cotton”, doi: 10.3390/polym11101664.
[26] L. Li, Z. Chen, J. Lu, M. Wei, Y. Huang, and P. Jiang, “Combustion Behavior and Thermal Degradation Properties of Wood Impregnated with Intumescent Biomass Flame Retardants: Phytic Acid, Hydrolyzed Collagen, and Glycerol,” vol. 6, p. 3930, 2021, doi: 10.1021/acsomega.0c05778.
[27] L. Costes et al., “Metallic phytates as efficient bio-based phosphorous flame retardant additives for poly(lactic acid),” Polym Degrad Stab, vol. 119, pp. 217-227, June 2015, doi: 10.1016/J.POLYMDEGRADSTAB.2015.05.014.
[28] X. Qian et al., “Novel flame retardants containing 9,10-dihydro-9-oxa-10-phosphaphenanthrene-10-oxide and unsaturated bonds: Synthesis, characterization, and application in the flame retardancy of epoxy acrylates,” Ind Eng Chem Res, vol. 52, no. 22, pp. 7307-7315, June 2013, doi: 10.1021/ie400872q.
[29] X. W. Cheng, Z. Y. Wang, W. J. Jin, and J. P. Guan, “Covalent flame-retardant functionalization of wool fabric using ammonium phytate with improved washing durability,” Ind Crops Prod, vol. 187, p. 115332, November 2022, doi: 10.1016/J.INDCROP.2022.115332.
[30] C. Gao, L. Zhou, S. Yao, C. Qin, and P. Fatehi, “Phosphorylated kraft lignin with improved thermal stability,” Int J Biol Macromol, vol. 162, pp. 1642-1652, November 2020, doi: 10.1016/j.ijbiomac.2020.08.088.
[31] B. Prieur et al., “Phosphorylation of lignin to flame retard acrylonitrile butadiene styrene (ABS),” Polym Degrad Stab, vol. 127, pp. 32-43, May 2016, doi: 10.1016/j.polymdegradstab.2016.01.015.
[32] G. L. Bykov and B. G. Ershov, “A sorbent based on phosphorylated lignin,” Russian Journal of Applied Chemistry, vol. 83, no. 2, pp. 316-319, February 2010, doi: 10.1134/S1070427210020254.
[33] Y. Guo, C. Cheng, T. Huo, Y. Ren, and X. Liu, “Highly effective flame retardant lignin/polyacrylonitrile composite prepared via solution blending and phosphorylation,” Polym Degrad Stab, vol. 181, November 2020, doi: 10.1016/j.polymdegradstab.2020.109362.
[34] S. J. Marciano, F. Avelino, L. R. R. da Silva, S. E. Mazzetto, and D. Lomonaco, “Microwave-assisted phosphorylation of organosolv lignin: new bio-additives for improvement of epoxy resins performance,” Biomass Convers Biorefin, vol. 12, no. 3, pp. 619-631, March 2022, doi: 10.1007/s13399-020-01048-7.
[35] Y. M. Zhang et al., “Synthesis of a lignin-based phosphorus-containing flame retardant and its application in polyurethane,” RSC Adv, vol. 8, no. 56, pp. 32252-32261, 2018, doi: 10.1039/c8ra05598j.
[36] M. v Efanov and A. I. Galochkin, “PHOSPHORYLATION OF TECHNICAL LIGNINS,” 2012.
[37] W. Xiong, X. Qiu, R. Zhong, and D. Yang, “Characterization of the adsorption properties of a phosphorylated kraft lignin-based polymer at the solid/liquid interface by the QCM-D approach,” Holzforschung, vol. 70, no. 10, pp. 937-945, October 2016, doi: 10.1515/HF-2015-0226/MACHINEREADABLECITATION/RIS.
[38] C. Gao, L. Zhou, S. Yao, C. Qin, and P. Fatehi, “Phosphorylated kraft lignin with improved thermal stability,” Int J Biol Macromol, vol. 162, pp. 1642-1652, November 2020, doi: 10.1016/J.IJBIOMAC.2020.08.088.
[39] C. Gao, L. Zhou, S. Yao, C. Qin, and P. Fatehi, “Phosphorylated kraft lignin with improved thermal stability,” Int J Biol Macromol, vol. 162, pp. 1642-1652, November 2020, doi: 10.1016/J.IJBIOMAC.2020.08.088.
[40] V. Carretier, M. F. Pucci, C. Lacoste, A. Regazzi, and J. M. Lopez-Cuesta, “An efficient solution to determine surface energy of powders and porous media: Application to untreated and treated lignin,” Appl Surf Sci, vol. 579, p. 152159, March 2022, doi: 10.1016/J.APSUSC.2021.152159.
[41] H. Qiao, Y. Liang, G. Xu, Y. Wang, J. Yang, and J. Hu, “Preparation, characterization and flame retardancy of phosphorus-containing poly-styrene-acrylate emulsion,” Des Monomers Polym, vol. 22, no. 1, pp. 114-121, January 2019, doi: 10.1080/15685551.2019.1616366.
[42] L. Oatway, T. Vasanthan, and J. H. Helm, “PHYTIC ACID,” http://dx.doi.org/10.1081/FRI-100108531, vol. 17, no. 4, pp. 419-431, 2007, doi: 10.1081/FRI-100108531.
[43] F. Kong, S. Wang, J. T. Price, M. K. R. Konduri, and P. Fatehi, “Water soluble kraft lignin-acrylic acid copolymer: synthesis and characterization,” Green Chemistry, vol. 17, p. 4355, 2015, doi: 10.1039/c5gc00228a.
[44] X. Meng et al., “Determination of hydroxyl groups in biorefinery resources via quantitative 31 P NMR spectroscopy,” Nat Protoc, vol. 14, no. 9, pp. 2627-2647, September 2019, doi: 10.1038/s41596-019-0191-1.
[45] R. Ravichandran et al., “Mimicking Native Extracellular Matrix with Phytic Acid-Crosslinked Protein Nanofibers for Cardiac Tissue Engineering,” Macromol Biosci, vol. 13, no. 3, pp. 366-375, March 2013, doi: 10.1002/MABI.201200391.
[46] P. Tomani, “THE LIGNOBOOST PROCESS,” CELLULOSE CHEMISTRY AND TECHNOLOGY Cellulose Chem. Technol, vol. 44, no. 3, pp. 53-58, 2010.
[47] D. R. Bhumkar and V. B. Pokharkar, “Studies on Effect of pH on Cross-linking of Chitosan With Sodium Tripolyphosphate: A Technical Note,” 2006, Accessed: Feb. 9, 2023. [Online]. Available: http://www.aapspharmscitech.org
[48] C. Cagnin, B. M. Simões, F. Yamashita, G. M. de Carvalho, and M. V. E. Grossmann, “pH sensitive phosphate crosslinked films of starch-carboxymethyl cellulose,” Polym Eng Sci, vol. 61, no. 2, pp. 388-396, February 2021, doi: 10.1002/PEN.25582.
[49] J. Y. Park and E. Y. Park, “Phosphorylation and citration of normal corn starch by dry heating with phytic acid and citric acid,” Int J Biol Macromol, vol. 226, pp. 312-320, January 2023, doi: 10.1016/J.IJBIOMAC.2022.12.028.
[50] M. Ataie, K. Sutherland, L. Pakzad, and P. Fatehi, “Experimental and modeling analysis of lignin derived polymer in flocculating aluminium oxide particles,” Sep Purif Technol, vol. 247, September 2020, doi: 10.1016/J.SEPPUR.2020.116944.
[51] L. Jiang, J. Guan, L. Zhao, J. Li, and W. Yang, “pH-dependent aggregation of citrate-capped Au nanoparticles induced by Cu2+ ions: The competition effect of hydroxyl groups with the carboxyl groups,” Colloids Surf A Physicochem Eng Asp, vol. 346, no. 1-3, pp. 216-220, August 2009, doi: 10.1016/J.COLSURFA.2009.06.023.
[52] H. Huo et al., “Phosphorylated wood designed as a biosorbent for effectively removing Ni2+ from wastewater,” Ind Crops Prod, vol. 188, November 2022, doi: 10.1016/J.INDCROP.2022.115727.
[53] D. Wang et al., “A Bio-Based Flame-Retardant Starch Based on Phytic Acid,” ACS Sustain Chem Eng, vol. 8, no. 27, pp. 10265-10274, July 2020, doi: 10.1021/ACSSUSCHEMENG.0C03277/ASSET/IMAGES/LARGE/SC0C03277_0005. JPEG.
[54] J. Pretula, K. Kaluzynski, B. Wisniewski, R. Szymanski, T. Loontjens, and S. Penczek, “Formation of Poly(ethylene phosphates) in Polycondensation of H 3 PO 4 with Ethylene Glycol. Kinetic and Mechanistic Study,” J Polym Sci Part A: Polym Chem, vol. 46, pp. 830-843, 2007, doi: 10.1002/pola.22427.
[55] S. P. J. Brooks, D. Oberleas, B. A. Dawson, B. Belonje, and B. J. Lampi, “Proposed phytic acid standard including a method for its analysis,” J AOAC Int, vol. 84, no. 4, pp. 1125-1129, 2001, doi: 10.1093/jaoac/84.4.1125.
[56] C. Gao, L. Zhou, S. Yao, C. Qin, and P. Fatehi, “Phosphorylated kraft lignin with improved thermal stability,” Int J Biol Macromol, vol. 162, pp. 1642-1652, November 2020, doi: 10.1016/j.ijbiomac.2020.08.088.
[57] F. Rol et al., “Cellulose phosphorylation comparison and analysis of phosphorate position on cellulose fibers,” Carbohydr Polym, vol. 229, February 2020, doi: 10.1016/j.carbpol.2019.115294.
[58] M. Farrokhi, M. Abdollahi, and A. Alizadeh, “An efficient method for straightforward phosphorylation of ethylene/vinyl alcohol copolymers using trialkyl phosphite/iodine,” Polymer (Guildf), vol. 169, pp. 215-224, April 2019, doi: 10.1016/j.polymer.2019.02.050.
[59] S. N. Sun, M. F. Li, T. Q. Yuan, F. Xu, and R. C. Sun, “Effect of ionic liquid/organic solvent pretreatment on the enzymatic hydrolysis of corncob for bioethanol production. Part 1: Structural characterization of the lignins,” Ind Crops Prod, vol. 43, no. 1, pp. 570-577, May 2013, doi: 10.1016/J.INDCROP.2012.07.074.
[60] N. M. Stark, D. J. Yelle, and U. P. Agarwal, “Techniques for Characterizing Lignin Chapter 4,” 2016, doi: 10.1016/B978-0-323-35565-0.00004-7.
[61] C. Crestini, H. Lange, M. Sette, and D. S. Argyropoulos, “On the structure of softwood kraft lignin,” vol. 19, p. 4104, 2017, doi: 10.1039/c7gc01812f.
[62] A. Hoffmann, J. P. Nong, A. Porzel, M. Bremer, and S. Fischer, “Modification of Lignoboost Kraft Lignin from softwoods with dihydroxybenzenes,” React Funct Polym, vol. 142, pp. 112-118, September 2019, doi: 10.1016/J.REACTFUNCTPOLYM.2019.06.011.
[63] C. Heitner, Don. Dimmel, and J. A. Schmidt, Lignin and lignans: advances in chemistry. CRC Press, Taylor & Francis, 2010.
[64] A. T. Bauman, G. M. Chateauneuf, B. R. Boyd, R. E. Brown, and P. P. N. Murthy, “Conformational inversion processes in phytic acid: NMR spectroscopic and molecular modeling studies,” Tetrahedron Lett, vol. 40, no. 24, pp. 4489-4492, June 1999, doi: 10.1016/S0040-4039(99)00816-3.
[65] G. J. Jiao, J. Ma, J. Hu, X. Wang, and R. Sun, “Hierarchical build-up of vertically oriented lignin-based aerogel for photothermally assisted uranium uptake and recovery from acidic wastewater,” J Hazard Mater, vol. 448, April 2023, doi: 10.1016/J.JHAZMAT.2023.130988.
[66] B. Prieur et al., “Phosphorylation of lignin to flame retard acrylonitrile butadiene styrene (ABS),” Polym Degrad Stab, vol. 127, pp. 32-43, May 2016, doi: 10.1016/J.POLYMDEGRADSTAB.2016.01.015.
[67] G. Nourry, D. Belosinschi, M. P. Boutin, F. Brouillette, and R. Zerrouki, “Hydrophobization of phosphorylated cellulosic fibers,” Cellulose, vol. 23, no. 6, pp. 3511-3520, December 2016, doi: 10.1007/S10570-016-1071-2/FIGURES/9.
[68] R. J. Coleman, G. Lawrie, L. K. Lambert, M. Whittaker, K. S. Jack, and L. GrØndahl, “Phosphorylation of Alginate: Synthesis, Characterization, and Evaluation of in Vitro Mineralization Capacity,” Biomacromolecules, vol. 12, pp. 889-897, 2011, doi: 10.1021/bmi1011773.
[69] F. Zhang et al., “Rational design of non-hazardous phytic acid-functionalized graphene oxide for polymer nanocomposites toward reinforcing corrosion resistance performance applications,” Colloids Surf A Physicochem Eng Asp, vol. 617, p. 126390, May 2021, doi: 10.1016/J.COLSURFA.2021.126390.
[70] H. Liu, J. Ma, J. Gong, and J. Xu, “The structure and properties of SnF2-SnO—P₂O₅ glasses,” J Non Cryst Solids, vol. 419, pp. 92-96, July 2015, doi: 10.1016/J.JNONCRYSOL.2015.03.040.
[71] Y. Yu et al., “Functionalized lignin by grafting phosphorus-nitrogen improves the thermal stability and flame retardancy of polypropylene,” Polym Degrad Stab, vol. 97, no. 4, pp. 541-546, April 2012, doi: 10.1016/J.POLYMDEGRADSTAB.2012.01.020.
[72] J. Yang et al., “Ash thermochemical behaviors of bamboo lignin from kraft pulping: Influence of washing process,” Renew Energy, vol. 174, pp. 178-187, August 2021, doi: 10.1016/J.RENENE.2021.04.036.
[73] X. Gao, Z. Cao, C. Li, J. Liu, X. Liu, and L. Guo, “Activated carbon fiber modified with hyperbranched polyethylenimine and phytic acid for the effective adsorption and separation of In(iii),” New Journal of Chemistry, 2022, doi: 10.1039/d2nj03111 f.
[74] B. Tian et al., “Facile bottom-up synthesis of partially oxidized black phosphorus nanosheets as metal-free photocatalyst for hydrogen evolution,” Proc Natl Acad Sci USA, vol. 115, no. 17, pp. 4345-4350, April 2018, doi: 10.1073/pnas.1800069115.
[75] C. Viornery et al., “Surface Modification of Titanium with Phosphonic Acid To Improve Bone Bonding: Characterization by XPS and ToF-SIMS,” 2002, doi: 10.1021/la010908i.
[76] M. Shimizu, Y. Tsushima, and S. Arai, “Electrochemical Na-Insertion/Extraction Property of Ni-Coated Black Phosphorus Prepared by an Electroless Deposition Method,” ACS Omega, vol. 2, no. 8, pp. 4306-4315, August 2017, doi: 10.1021/acsomega.7b00950.
[77] C. Gao, L. Zhou, S. Yao, C. Qin, and P. Fatehi, “Phosphorylated kraft lignin with improved thermal stability,” Int J Biol Macromol, vol. 162, pp. 1642-1652, November 2020, doi: 10.1016/J.IJBIOMAC.2020.08.088.
[78] M. Wqdrzyk, R. Janus, M. Lewandowski, and A. Magdziarz, “On mechanism of lignin decomposition—Investigation using microscale techniques: Py-GC-MS, Py-FT-IR and TGA,” Renew Energy, vol. 177, pp. 942-952, November 2021, doi: 10.1016/J.RENENE.2021.06.006.
[79] C. Gao, L. Zhou, S. Yao, C. Qin, and P. Fatehi, “Phosphorylated kraft lignin with improved thermal stability,” Int J Biol Macromol, vol. 162, pp. 1642-1652, November 2020, doi: 10.1016/J.IJBIOMAC.2020.08.088.
[80] I. E. Raschip, G. E. Hitruc, C. Vasile, and M. C. Popescu, “Effect of the lignin type on the morphology and thermal properties of the xanthan/lignin hydrogels,” Int J Biol Macromol, vol. 54, no. 1, pp. 230-237, March 2013, doi: 10.1016/J.IJBIOMAC.2012.12.036.
[81] I. Ribca et al., “Exploring the Effects of Different Cross-Linkers on Lignin-Based Thermoset Properties and Morphologies,” 2021, doi: 10.1021/acssuschemeng.0c07580.
[82] S. Luo, J. Cao, and A. G. McDonald, “Cross-linking of technical lignin via esterification and thermally initiated free radical reaction,” Ind Crops Prod, vol. 121, pp. 169-179, October 2018, doi: 10.1016/J.INDCROP.2018.05.007.
[83] S. Montserrat, “Effect of crosslinking density on AC,(T,) in an epoxy network,” 1995.
[84] H. Li and A. G. McDonald, “Fractionation and characterization of industrial lignins,” Ind Crops Prod, vol. 62, pp. 67-76, December 2014, doi: 10.1016/J.INDCROP.2014.08.013.
[85] D. Tarasov, M. Leitch, and P. Fatehi, “Thermal properties of lignocellulosic precipitates from neutral sulfite semichemical pulping process,” Fuel Processing Technology, vol. 158, pp. 146-153, April 2017, doi: 10.1016/J.FUPROC.2016.12.017.
[86] N. Zhang et al., “Lignin-based phenolic resin modified with whisker silicon and its application,” Journal of Bioresources and Bioproducts, vol. 5, no. 1, pp. 67-77, February 2020, doi: 10.1016/J.JOBAB.2020.03.008.
[87] Y. Yu et al., “Functionalized lignin by grafting phosphorus-nitrogen improves the thermal stability and flame retardancy of polypropylene,” Polym Degrad Stab, vol. 97, no. 4, pp. 541-546, April 2012, doi: 10.1016/J.POLYMDEGRADSTAB.2012.01.020.
[88] N. Zhang et al., “Lignin-based phenolic resin modified with whisker silicon and its application,” Journal of Bioresources and Bioproducts, vol. 5, no. 1, pp. 67-77, February 2020, doi: 10.1016/J.JOBAB.2020.03.008.
[89] Z. Ma, D. Meng, Z. Zhang, and Y. Wang, “Synergistic effect of green phosphorus-containing bio-based material and two-dimensional layered material composite on flame-retardant property of polyvinyl alcohol,” Thermochim Acta, vol. 707, p. 179118, January 2022, doi: 10.1016/J.TCA.2021.179118.
[90] F. Laoutid, H. Vahabi, M. R. Saeb, and P. Dubois, “Lignin as a flame retardant for biopolymers,” Micro and Nanolignin in Aqueous Dispersions and Polymers: Interactions, Properties, and Applications, pp. 173-202, January 2022, doi: 10.1016/B978-0-12-823702-1.00006-2.
[91] L. Yan, Z. Xu, and N. Deng, “Effects of polyethylene glycol borate on the flame retardancy and smoke suppression properties of transparent fire-retardant coatings applied on wood substrates,” Prog Org Coat, vol. 135, pp. 123-134, October 2019, doi: 10.1016/J.PORGCOAT.2019.05.043.
[92] M. M. Velencoso, A. Battig, J. C. Markwart, B. Schartel, and F. R. Wurm, “Molecular Firefighting—How Modern Phosphorus Chemistry Can Help Solve the Challenge of Flame Retardancy,” Angewandte Chemie—International Edition, vol. 57, no. 33, pp. 10450-10467, August 2018, doi: 10.1002/ANIE.201711735.
[93] C.-D. Varganici, L. Rosu, A. Bifulco, D. Rosu, F. Mustata, and S. Gaan, “Recent advances in flame retardant epoxy systems from reactive DOPO-based phosphorus additives,” Polym Degrad Stab, vol. 202, p. 110020, August 2022, doi: 10.1016/J.POLYMDEGRADSTAB.2022.110020.
[94] A. Overview, M. Lewin, and H. F. Mark, “Synergistic and Catalytic Effects in Flame Retardancy of Polymeric Materials&mdash;”
[95] K. Bansal, S. Swarup, and M. Quadir, “Halogen free organic coatings for flame retarding applications using phytic acid conjugated UV-curable resin,” Prog Org Coat, vol. 172, p. 107093, November 2022, doi: 10.1016/J.PORGCOAT.2022.107093.
[96] H. Bin Yuan, R. C. Tang, and C. B. Yu, “Flame retardant functionalization of microcrystalline cellulose by phosphorylation reaction with phytic acid,” Int J Mol Sci, vol. 22, no. 17, September 2021, doi: 10.3390/ijms22179631.
[97] J. Liu et al., “Eco-friendly flame retardant and smoke suppression coating containing boron compounds and phytic acids for nylon/cotton blend fabrics,” Ind Crops Prod, vol. 186, p. 115239, October 2022, doi: 10.1016/J.INDCROP.2022.115239.
[98] P. Wang and Z. Cai, “Highly efficient flame-retardant epoxy resin with a novel DOPO-based triazole compound: Thermal stability, flame retardancy and mechanism,” Polym Degrad Stab, vol. 137, pp. 138-150, March 2017, doi: 10.1016/J.POLYMDEGRADSTAB.2017.01.014.
[99] Y. J. Lee, B. Bingöl, T. Murakhtina, D. Sebastiani, W. H. Meyer, G. Wegner and H. W. Spiess, J. Phys. Chem. B, 2007, 111, 9711-9721.
[100]. Z. Ma, Q. Sun, J. Ye, Q. Yao and C. Zhao, J. Anal. Appl. Pyrolysis, 2016, 117, 116-124.
[101] A. Sethurajaperumal, A. Manohar, A. Banerjee, E. Varrla, H. Wang and K. Ostrikov, Nanoscale Adv., 2021, 14, 4235-4243.
[102] F. Wang, J. Y. Cheong, Q. He, G. Duan, S. He, L. Zhang, Y. Zhao, I. D. Kim and S. Jiang, Chem. Eng. J., 2021, 414, 128767.
[103] P. Parcheta-Szwindowska, J. Habaj, I. Krzemiriska and J. Datta, Int J Mol Sci, 2024, 25, 5512.
[104] D. Niu, W. Yu, W. Yang, P. Xu, T. Liu, Z. Wang, X. Yan and P. Ma, Chem. Eng. J., 2023, 474, 145753.
[105] H. Zheng, X. Han, Q. Wei, C. Zheng, C. Huang, Z. Jin, Y. Li and J. Zhou, Chem. Eng. J., 2022, 437, 135412.
[106] K. Wang, D. Meng, S. Wang, J. Sun, H. Li, X. Gu and S. Zhang, Ind Crops Prod, 2021,176,114364.
[107] H. Yu, Y. Xia, X. Xu, N. Zarshad, M. Wu and H. Ni, J. Appl. Polym. Sci., 2020, 137, 49256.
[108] S. Gaan and G. Sun, J Anal Appl Pyrolysis, 2007, 78, 371-377.
[109] O. Karlsson, C.-F. Lin, D. Jones, and D. Sandberg, in Proceedings of the Tenth European Conference on Wood Modification, 2022, 25-26.
[110] J.-H. Lee, D. Jang, I. Yang, S. Mu Jo and S. Lee, J. Appl. Polym. Sci., 2022, 139, e52519.
[111] B. Ramadhoni, A. Rifathin and ⋅ Frita Yuliati, J. Inst. Eng. India Ser. D, 2023, Series D, 00564-w.
[112] B. Prieur, M. Meub, M. Wittemann, R. Klein, S. Bellayer, G. Fontaine and S. Bourbigot, RSC Adv., 2017, 7, 16866-16877.
[113] J. Rusmirovid, V. Lukić, T. Kovačević, M. Bogosavljević, S. Brzić, A. Marinković and T. Stevanović, Scientific Technical Review, 2019, 69, 16-22.

TABLE 1
The effect of molar ratio in temperature 80° C. for 240 min.

| | Ratio | | Charge |
|---|---|---|---|
| Sample | KrL:PHA | Solubility | density |
| ID | (mol:mol) | (%) | (mmol/g) |
| PK1 | 1:0.02 | 97 | −1.8 |
| PK2 | 1:0.06 | 93 | −2.3 |
| PK3 | 1:0.16 | 94 | −2.9 |
| PK4 | 1:0.2 | 98 | −2.8 |
| PK5 | 1:0.3 | 97 | −3.1 |
| PK6 | 1:0.4 | 72 | −4.3 |

TABLE 2
The effect of pH adjustment and solvent in the molar ratio
of 1:0.4 (KrL:PHA, mol:mol) at 80° C. for 240 min.

| | | pH | | Charge |
|---|---|---|---|---|
| Sample | | adjustment | Solubility | density |
| ID | Solvent | conditions | (%) | (mmol/g) |
| PK6 | DI | 1 | 72 | −4.3 |
| | Water | | | |
| PK7 | DI | 2 | 70 | −4.7 |
| | Water | | | |
| PK8 | DI | 3 | 97 | −4 |
| | Water | | | |

TABLE 3
The effect of solvent in the molar ratio of 1:0.4 (KrL:PHA,
mol:mol) at different temperature for 240 min.

| | | | Solubility | Charge density |
|---|---|---|---|---|
| Sample ID | Solvent | Temperature | (%) | (mmol/g) |
| PK9 | Urea | 80 | 97 | −3.8 |
| PK10 | Urea | 100 | 98 | −4 |
| PK11 | Urea | 120 | 98 | −3.9 |

TABLE 4
The effect of different times on the reaction in the
molar ratio of 1:0.4 (KrL:PHA, mol:mol) at 80° C.

| | | | Charge |
|---|---|---|---|
| | Time | Solubility | density |
| Sample ID | (min) | (%) | (mmol/g) |
| PK12 | 20 | 97 | −4.2 |
| PK13 | 40 | 97 | −3.8 |
| PK14 | 60 | 95 | −3.5 |
| PK15 | 120 | 98 | −3.4 |
| PK16 | 180 | 98 | −3.7 |
| PK17 | 240 | 97 | −4 |
| CK | 240 and 20 | 93 | −0.8 |

TABLE 5
The effect of different temperatures on the reaction in
the molar ratio of 1:0.4 (KrL:PHA, mol:mol) in 20 min.

| | | | Charge |
|---|---|---|---|
| Sample | Temperature | Solubility | density |
| ID | (° C.) | (%) | (mmol/g) |
| PK18 | 20 | 97 | −4.2 |
| PK19 | 40 | 93 | −4 |
| PK20 | 60 | 96 | −4 |
| PK21 | 80 | 95 | −3.5 |

TABLE 6
Elemental analysis of CHNS, ICP-AES, and XPS.

| | | | | | ICP- | | | |
|---|---|---|---|---|---|---|---|---|
| | CHNS | | | | AES | XPS | | |
| Sample | C | H | N | S | P | P | Mw | Mn |
| ID | (%) | (%) | (%) | (%) | (g/g) | (%) | (g/mol) | (g/mol) |
| PK1 | 54.64 | 6.49 | 0 | 1.17 | 0.008 | 0.8 | 3920 | 2543 |
| PK2 | 52.11 | 5.59 | 0 | 1.15 | 0.013 | 1.7 | 4380 | 3779 |
| PK3 | 48.25 | 5.92 | 0 | 1.07 | 0.033 | 4 | 4561 | 4194 |
| PK4 | 47 | 5.92 | 0 | 1.02 | 0.037 | 3 | 4577 | 4161 |
| PK5 | 45.46 | 5.44 | 0 | 0.93 | 0.042 | 4.4 | 4528 | 4139 |
| PK6 | 43.21 | 4.99 | 0 | 0.84 | 0.043 | 4.2 | 4554 | 4233 |
| PK7 | 47.95 | 6.61 | 0 | 0.01 | 0.07 | — | 4833 | 4611 |
| PK8 | 44.42 | 5.6 | 0 | 0.01 | 0.07 | — | 4668 | 4412 |
| PK9 | 44.27 | 5.6 | 0 | 0.01 | 0.07 | — | 4747 | 4482 |
| PK10 | 51.07 | 6.81 | 0 | 0.01 | 0.07 | — | 4778 | 4641 |
| PK11 | 49.44 | 6.35 | 0 | 0.01 | 0.06 | — | 4781 | 4642 |
| PK12 | 39.23 | 5.22 | 0 | 0.72 | 0.072 | — | 4671 | 4383 |
| PK13 | 41.47 | 5.37 | 0 | 0.82 | 0.071 | — | 4659 | 4378 |
| PK14 | 41.47 | 5.65 | 0 | 0.83 | 0.067 | — | 4664 | 4382 |
| PK15 | 43.15 | 5.74 | 0 | 0.84 | 0.062 | — | 4670 | 4429 |
| PK16 | 40.31 | 5.56 | 0 | 0.76 | 0.067 | — | 4652 | 4240 |
| PK17 | 42.63 | 5.69 | 0 | 0.82 | 0.074 | — | 4668 | 4412 |
| PK18 | 40.29 | 5.66 | 0 | 0.84 | 0.072 | — | 4771 | 4624 |
| PK19 | 41.16 | 5.66 | 0 | 0.86 | 0.071 | — | 4784 | 4589 |
| PK20 | 41.27 | 5.63 | 0 | 0.84 | 0.076 | — | 4811 | 4640 |
| PK21 | 41.37 | 5.65 | 0 | 0.85 | 0.074 | — | 4664 | 4382 |
| CK | 60.53 | 6.64 | 0 | 1.3 | <0.02 | 0 | 3268 | 1690 |
| KrL | 62.71 | 6.82 | 0 | 1.6 | 0 | 0 | — | — |

TABLE 7
The OH functional group content mmol/g obtained
via quantitative ³¹P-NMR analysis.

| | Aliphatic | Phenolic | C₅- | Guaiacyl | | Carboxylic |
|---|---|---|---|---|---|---|
| Sample | OH | OH | substituted | OH | p-Hydroxyphenyl | acid OH |
| name | (mmol/g) | (mmol/g) | (mmol/g) | (mmol/g) | OH (mmol/g) | (mmol/g) |
| KrL | 1.72 | 3.33 | 1.5 | 1.6 | 0.11 | 0.41 |
| PK18 | 0.63 | 0.71 | 0.29 | 0.39 | 0.02 | 0.06 |

TABLE 8
Thermal analysis data of KrL and PK18.

| | | | | Char | | Cₚ |
|---|---|---|---|---|---|---|
| Sample | T_{d} | Tₒₙₛₑₜ | Tₘₐₓ | residue | T_{g} | J (g · |
| name | (° C.) | (° C.) | (° C.) | (wt. %) | (° C.) | ° C.)⁻¹ |
| KrL | 202 ± 2 | 260 ± 2 | 545 | 3 | 180.8 | 0.3808 |
| PHKL | 262 ± 2 | 300 ± 2 | 650 | 50 | 215.22 | 0.0544 |

TABLE 9
Comparative study of lignin phosphorylation routes available in the literature.

| | | | | | Char | | |
|---|---|---|---|---|---|---|---|
| Source of | Reagent | Reaction | | TGA and | residue | | |
| lignin | (reagent:lignin) | condition | Solvent | DTG | at 800° C. | Application | ref |
| Softwood | Ammonium | 1 h at | Urea | Tₘₐₓ from | From 0% | Not tested | 30 |
| kraft lignin | dihydrogen | 70° C. | | 541° C. to | to 15% | | |
| | phosphate 9:1 | | | 620° C. | | | |
| | (mol:mol) | | | | | | |
| Softwood | Phosphoric | 50° C. | Acetone | Not | Not | Not tested | 109 |
| kraft lignin | acid (85%) | | and urea | reported | reported | | |
| | 0.5:0.14 (g:g) | | | | | | |
| Kraft lignin | Phosphorus | 1 to 24 h | Tetrahydro- | Tₘₐₓ not | From 0% | Polypropylene- | 110 |
| | pentoxide | at 70° C. | furan | reported | to 38% | based | |
| | 2.5:1 (phr:g) | | | | | composites | |
| Alkaline | Phosphorus | 2 h at | Methane | Tₘₐₓ from | From | Epoxy resin | 111 |
| lignin | pentoxide 5.5:1 | 5° C. | sulfonic acid, | 465° C. to | 44.4% to | | |
| | and 2.5:1 | Nitrogen | purification | 572° C. and | 13.5% and | | |
| | (mol:mol) | gas | by diethyl | 607° C. | 10.3% | | |
| | | | ether, acetone, | | | | |
| | | | or methanol | | | | |
| Kraft lignin | Phosphorus | 7 to 8 h | Tetrahydro- | Tₘₐₓ from | From 45% | Not tested | 112 |
| | pentoxide | at room | furan | 370° C. to | to 53% | | |
| | Not reported | temper- | | 409° C. | | | |
| Kraft lignin | Phosphorus | ature | Mixture of | Not | Not | polyester based | 113 |
| | chloride 6.5:10 | 17 h at | CHCl3/N- | available | available | composites | |
| | (g:g) | 60° C. | methyl-2- | | | | |
| | | | pyrrolidone | | | | |
| | | | precipitation | | | | |
| | | | and washed | | | | |
| | | | in cooled | | | | |
| | | | isopropyl | | | | |
| | | | alcohol and | | | | |
| | | | diethyl ether | | | | |
| Kraft lignin | Phytic acid | 20 min at | Water | Tₘₐₓ from | From 0% | Coating | This |
| | 0.4:1 | room temp- | | 545° C. to | to 50% | | work |
| | (mol:mol) | erature | | 640° C. | | | |

1. A method of preparing a flame modified lignin composition comprising:
mixing a quantity of lignin with phytic acid in water at a ratio of about 1 part lignin per about 0.2 to about 0.6 parts phytic acid (mol/mol) at a pH of about 9 to about 12 for at least about 20 minutes at a temperature of about 20-80° C.; and
recovering the modified lignin composition.

2. The method according to claim 1 comprising:
mixing a quantity of lignin with phytic acid in water at a ratio of 1 part lignin per 0.2 to 0.6 parts phytic acid (mol/mol) at a pH of 9 to 12 for at least 20 minutes at a temperature of 20-80° C.; and
recovering the modified lignin composition.

3. The method according to claim 1 wherein the ratio is about 1 part lignin per about 0.4 parts phytic acid (mol/mol).

4. The method according to claim 1 wherein the ratio is 1 part lignin per 0.4 parts phytic acid (mol/mol).

5. The method according to claim 1 wherein the pH is from about 9 to about 11.

6. The method according to claim 1 wherein the pH is from 9 to 11.

7. The method according to claim 1 wherein the pH is about 9.

8. The method according to claim 1 wherein the pH is adjusted by addition of a base.

9. The method according to claim 8 wherein the base is NaOH.

10. The method according to claim 1 wherein the lignin is kraft lignin.

11. The method according to claim 1 wherein, following the reaction, the reaction medium is neutralized.

12. The method according to claim 11 wherein the reaction medium is neutralized with H₂SO₄.

13. The method according to claim 11 wherein following neutralization, the modified lignin is dialyzed.

14. The method according to claim 1 wherein the modified lignin is phosphorylated lignin.

15. The method according to claim 1 wherein the pH of the reaction is adjusted after mixing the lignin and the phytic acid.

16. Use of the modified lignin composition according to claim 1 in a flame retardant material.

17. A method of increasing flame retardancy of a wood product comprising applying a coating comprising the modified lignin composition according to claim 1 to a surface of the wood product.
